(19) United States
(12) Patent Application Publication
(10) Pub. No.: US 2025/0226854 A1
(43) Pub. Date: Jul. 10, 2025

(54) SYSTEMS AND METHODS OF EXCHANGING DATA USING A COMMUNICATION LINK

(71) Applicant: QUALCOMM Incorporated, San Diego, CA (US)

(72) Inventors: Engin IPEK, San Diego, CA (US); Goran GORAN, San Diego, CA (US); Hamza OMAR, San Diego, CA (US); Xiaochen GUO, Los Angeles, CA (US); Bharatheesha Sudarshan JAGIRDAR, Vista, CA (US); Christophe AVOINNE, San Diego, CA (US); Bohuslav RYCHLIK, San Diego, CA (US); Matthew SEVERSON, Austin, TX (US); Jeffrey GEMAR, San Diego, CA (US)

(21) Appl. No.: 18/407,672

(22) Filed: Jan. 9, 2024

(51) Int. Cl. H04B 3/32

(52) U.S. Cl. CPC H04B 3/32

(57) ABSTRACT

A device includes a transmitter configured to obtain a particular set of bit values to be sent via a set of wires of a communication link. The transmitter is also configured to determine, based on a transition pattern associated with the particular set of bit values, whether to send the particular set of bit values during a single transmission period or during multiple transmission periods. The transmitter is further configured to send the particular set of bit values based on the determination.

### I. FIELD

The present disclosure is generally related to exchanging data using a communication link.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to exchange data between different components using a communication link. For example, a communication link can be used as a shared communication pathway to exchange data between a processor, a memory, and one or more peripherals. The communication link consists of multiple wires that carry signals and are closely spaced within an available chip area. Crosstalk occurs when signals on one wire unintentionally affect signals on adjacent wires. For example, when a signal transitions from low to high or high to low, it generates an electromagnetic field that can induce a voltage in nearby wires, potentially altering the signal's voltage level and resulting in an incorrect data transfer.

### III. SUMMARY

According to one implementation of the present disclosure, a device includes a transmitter configured to obtain a particular set of bit values to be sent via a set of wires of a communication link. The transmitter is also configured to determine, based on a transition pattern associated with the particular set of bit values, whether to send the particular set of bit values during a single transmission period or during multiple transmission periods. The transmitter is further configured to send the particular set of bit values based on the determination.

According to one implementation of the present disclosure, a method includes obtaining, at a transmitter of a device, a particular set of bit values to be sent via a set of wires of a communication link. The method also includes determining, based on a transition pattern associated with the particular set of bit values, whether to send the particular set of bit values during a single transmission period or during multiple transmission periods. The method further includes sending, via the transmitter, the particular set of bit values based on the determination.

According to one implementation of the present disclosure, a non-transitory computer-readable medium stores instructions that, when executed by at least one processor, cause the at least one processor to obtain, at a transmitter of a device, a particular set of bit values to be sent via a set of wires of a communication link. The instructions, when executed by the at least one processor, also cause the at least one processor to determine, based on a transition pattern associated with the particular set of bit values, whether to send the particular set of bit values during a single transmission period or during multiple transmission periods. The instructions, when executed by the at least one processor, further cause the at least one processor to send, via the transmitter, the particular set of bit values based on the determination.

According to one implementation of the present disclosure, an apparatus includes means for obtaining, at a transmitter of a device, a particular set of bit values to be sent via a set of wires of a communication link. The apparatus also includes means for determining, based on a transition pattern associated with the particular set of bit values, whether to send the particular set of bit values during a single transmission period or during multiple transmission periods. The apparatus further includes means for sending, via the transmitter, the particular set of bit values based on the determination.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a system operable to exchange data using a communication link, in accordance with some examples of the present disclosure.

FIG. 2 is a diagram of an illustrative aspect of operations at a link encoder and a link decoder associated with a cross-talk pattern detection example, in accordance with some examples of the present disclosure.

FIG. 3A is a diagram of an illustrative aspect of operations at the link encoder associated with the cross-talk pattern detection example, in accordance with some examples of the present disclosure.

FIG. 3B is a diagram of an illustrative aspect of operations at the link encoder associated with the cross-talk pattern detection example, in accordance with some examples of the present disclosure.

FIG. 3C is a diagram of an illustrative aspect of operations at the link decoder associated with the cross-talk pattern detection example, in accordance with some examples of the present disclosure.

FIG. 4A is a diagram of an illustrative aspect of operations at the link encoder associated with the cross-talk pattern detection example, in accordance with some examples of the present disclosure.

FIG. 4B is a diagram of an illustrative aspect of operations at the link decoder associated with the cross-talk pattern detection example, in accordance with some examples of the present disclosure.

FIG. 5A is a diagram of an illustrative aspect of operations at the link encoder associated with the cross-talk pattern detection example, in accordance with some examples of the present disclosure.

FIG. 5B is a diagram of an illustrative aspect of operations at the link decoder associated with the cross-talk pattern detection example, in accordance with some examples of the present disclosure.

FIG. 6 is a diagram of an illustrative aspect of operations at a link encoder and a link decoder associated with an encoding pattern detection example, in accordance with some examples of the present disclosure.

FIG. 7A is a diagram of an illustrative aspect of operations at the link encoder associated with the encoding pattern detection example, in accordance with some examples of the present disclosure.

FIG. 7B is a diagram of an illustrative aspect of operations at the link encoder associated with the encoding talk pattern detection example, in accordance with some examples of the present disclosure.

FIG. 8A is a diagram of an illustrative aspect of operations at the link encoder associated with the encoding pattern detection example, in accordance with some examples of the present disclosure.

FIG. 8B is a diagram of an illustrative aspect of operations at the link encoder associated with the encoding pattern detection example, in accordance with some examples of the present disclosure.

FIG. 8C is a diagram of an illustrative aspect of operations at the link decoder associated with the encoding pattern detection example, in accordance with some examples of the present disclosure.

FIG. 9A is a diagram of an illustrative aspect of operations at the link encoder associated with the encoding pattern detection example, in accordance with some examples of the present disclosure.

FIG. 9B is a diagram of an illustrative aspect of operations at the link decoder associated with the encoding pattern detection example, in accordance with some examples of the present disclosure.

FIG. 10 is a diagram of an illustrative aspect of operations at a link encoder and a link decoder associated with a flag wire example, in accordance with some examples of the present disclosure.

FIG. 11A is a diagram of an illustrative aspect of operations at the link encoder associated with the flag wire example, in accordance with some examples of the present disclosure.

FIG. 11B is a diagram of an illustrative aspect of operations at the link decoder associated with the flag wire example, in accordance with some examples of the present disclosure.

FIG. 12A is a diagram of an illustrative aspect of operations at the link encoder associated with the flag wire example, in accordance with some examples of the present disclosure.

FIG. 12B is a diagram of an illustrative aspect of operations at the link decoder associated with the flag wire example, in accordance with some examples of the present disclosure.

FIG. 13A is a diagram of an illustrative aspect of operations at the link encoder associated with the flag wire example, in accordance with some examples of the present disclosure.

FIG. 13B is a diagram of an illustrative aspect of operations at the link decoder associated with the flag wire example, in accordance with some examples of the present disclosure.

FIG. 14 is a diagram of a particular implementation of a method of transmitting data using a communication link that may be performed by a device of FIG. 1, in accordance with some examples of the present disclosure.

FIG. 15 is a diagram of a particular implementation of a method of receiving data using a communication link that may be performed by the device of FIG. 1, in accordance with some examples of the present disclosure.

FIG. 16 illustrates various electronic devices that may integrate a communication link, a transmitter, a receiver, a link encoder, and/or a link decoder described herein.

### V. DETAILED DESCRIPTION

A communication link consists of multiple wires that carry signals and are closely spaced. For example, the communication link can include an on-chip bus consisting of multiple wires that are closely spaced within an available chip area. Crosstalk occurs when signals on one wire unintentionally affect signals on adjacent wires. For example, when a signal transitions from low to high or high to low, it generates an electromagnetic field that can induce a voltage in nearby wires, potentially altering the signal's voltage level and resulting in an incorrect data transfer.

Systems and methods of exchanging data using a communication link are disclosed. For example, data is to be sent from a first component (e.g., a processor) of a device via a communication link to a second component (e.g., memory) of the device. A transmitter, based on determining whether a transition pattern is detected, determines whether to send bit values during a single transmission period or during multiple transmission periods.

The transmitter determines that a cross-talk pattern is detected if sending a particular set of bit values using a subset of wires of the communication link would cause bit values on two adjacent wires to transition in opposite directions during successive transmission periods. In an example, the transmitter has sent a first set of encoded bit values via a first subset of wires of the communication link during a first transmission period. The transmitter determines whether a cross-talk pattern is detected based on a comparison of the first set of encoded bit values and a set of input bit values that are to be sent next using the first subset of wires, where the first subset of wires includes a first wire adjacent to a second wire of the communication link. If the first wire and the second wire were used to send a 0 and a 1, respectively, during a prior transmission period, the transmitter determines that a cross-talk pattern is detected if sending the set of input bit values would cause the first wire and the second wire to send a 1 and a 0, respectively. Having the bit values on two adjacent wires transition in opposite directions has a high likelihood of causing a cross-talk problem.

The transmitter, based on determining that a cross-talk pattern is detected, sends the set of input bit values during multiple transmission periods. For example, the transmitter sends the set of input bit values during two transmission periods. To illustrate, the first subset of wires includes even wires and odd wires and the set of input bit values includes even bit values and odd bit values. The transmitter, during a second transmission period, keeps the even wires static and sends the odd bit values via the odd wires. The static even bit values and the odd bit values correspond to a second set of encoded bit values. During a third transmission period, the transmitter keeps the odd wires static and sends the even bit values via the even wires. The static odd bit values and the even bit values correspond to a third set of encoded bit values that is the same as the set of input bit values. Keeping the even wires static in the second transmission period and the odd wires static in the third transmission period provides a solution to the cross-talk problem by ensuring that adjacent wires do not transition in opposite directions.

A receiver receives the first set of encoded bit values, the second set of encoded bit values, and the third set of encoded bit values during the first transmission period, the second transmission period, and the third transmission period, respectively. The receiver determines whether an encoding pattern is detected indicating that multiple transmission periods were used to send a set of input bit values. In an example, the receiver determines whether two transmission periods were used to send a set of input bit values. To illustrate, the receiver determines whether a first transition pattern (e.g., even static values) is detected based on a comparison of the first set of encoded bit values and the second set of encoded bit values and whether a second transition pattern (e.g., odd static values) is detected based on a comparison of the second set of encoded bit values and the third set of encoded bit values. The receiver, in response to determining that the first transition pattern and the second transition pattern are detected, determines that the encoding pattern is detected. The receiver, in response to determining that the encoding pattern is detected, discards the second set of encoded bit values and outputs the third set of encoded bit values as decoded data that is the same as the set of input bit values.

In some cases, input bit values can satisfy the encoding pattern. As an illustrative example, a first set of input bit values (e.g., 1010), a second set of input bit values (e.g., 1111), and a third set of input bit values (e.g., 1101) do not satisfy the cross-talk pattern. However, if the transmitter sends the first set of input bit values, the second set of input bit values, and the third set of input bit values as a first set of encoded bit values, a second set of encoded bit values, and a third set of encoded bit values, respectively, in successive transmission periods over the same subset of wires, the encoding pattern would be satisfied at the receiver and the receiver would discard the second set of encoded bit values.

In a first implementation, the communication link includes a flag wire associated with a subset of wires. The transmitter sends a flag bit value concurrently with sending a particular set of bit values via the subset of wires. The flag bit value indicates whether a single transmission period or multiple transmission periods are being used to send the particular set of bit values. In the illustrative example, the transmitter sends the first set of input bit values, the second set of input bit values, and the third set of input bit values as a first set of encoded bit values, a second set of encoded bit values, and a third set of encoded bit values, respectively, in successive transmission periods over the subset of wires concurrently with sending a first flag bit value (e.g., 0) via the flag wire indicating that each set of bit values is being sent in a single transmission period. The flag wire provides one solution to the problem of input bit values getting incorrectly discarded because of matching the encoding pattern.

In a second implementation, the transmitter, in response to determining that either the cross-talk pattern or the encoding pattern is detected, sends a particular set of input bit values during multiple transmission periods. In the illustrative example, the transmitter sends the particular set of input values during two transmission periods. For example, the transmitter sends the first set of input bit values (e.g., 1010) as a first set of encoded bit values during a first transmission period, and sends the second set of input bit values (e.g., 1111) as a second set of encoded bit values during a second transmission period. The transmitter, in response to determining that the encoding pattern is detected, sends the third set of input bit values during two transmission periods. To illustrate, the third set of input bit values includes even bit values and odd bit values. The transmitter, during a third transmission period, keeps the even wires static and sends the odd bit values via the odd wires. The static even bit values and the odd bit values correspond to a third set of encoded bit values. During a fourth transmission period, the transmitter keeps the odd wires static and sends the even bit values via the even wires. The static odd bit values and the even bit values correspond to a fourth set of encoded bit values that is the same as the third set of input bit values. The receiver, in response to determining that the encoding pattern is detected, discards the third set of encoded bit values and outputs the fourth set of encoded bit values as decoded data that is the same as the third set of input bit values. Sending input bit values in multiple transmission periods when the encoding pattern is detected provides another solution to the problem of input bit values getting incorrectly discarded because of matching the encoding pattern. This solution does not use additional wires as flag wires. It should be understood that two transmission periods are provided as an illustrative example of the multiple transmission periods, in other examples the multiple transmission periods can include more than two transmission periods.

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. For ease of reference herein, such features are generally introduced as “one or more” features and are subsequently referred to in the singular or optional plural (as indicated by “(s)”) unless aspects related to multiple of the features are being described.

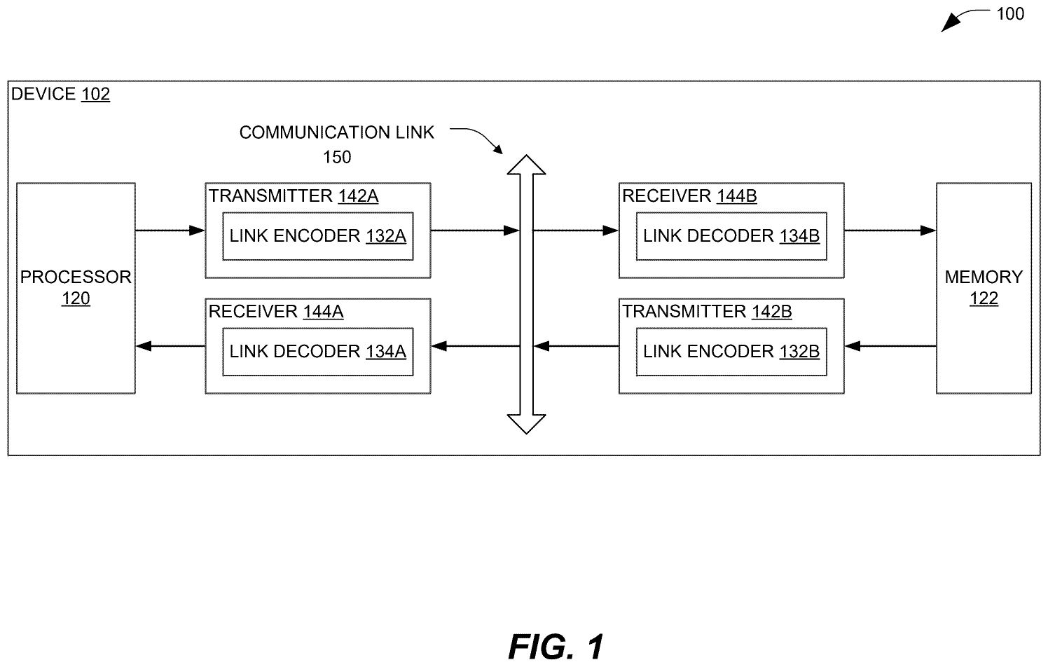

In some drawings, multiple instances of a particular type of feature are used. Although these features are physically and/or logically distinct, the same reference number is used for each, and the different instances are distinguished by addition of a letter to the reference number. When the features as a group or a type are referred to herein, e.g., when no particular one of the features is being referenced, the reference number is used without a distinguishing letter. However, when one particular feature of multiple features of the same type is referred to herein, the reference number is used with the distinguishing letter. For example, referring to FIG. 1, multiple transmitters are illustrated and associated with reference numbers 142A and 142B. When referring to a particular one of these transmitters, such as a transmitter 142A, the distinguishing letter “A” is used. However, when referring to any arbitrary one of these transmitters or to these transmitters as a group, the reference number 142 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

Referring to FIG. 1, a particular illustrative aspect of a system configured to exchange data using a communication link is disclosed and generally designated 100. The system 100 includes a device 102 that includes a plurality of components that are configured to exchange data using a communication link 150.

In a particular embodiment, the device 102 includes a processor 120 that is coupled via the communication link 150 to a memory 122. The device 102 includes a plurality of transmitters 142 and a plurality of receivers 144 that are each coupled to the communication link 150. For example, the device 102 includes a transmitter 142A and a receiver 144A that are each coupled to the processor 120 and to the communication link 150. The transmitter 142A is configured to obtain data from the processor 120 for transmission via the communication link 150 to one or more components of the device 102. The receiver 144A is configured to receive data from one or more components of the device 102 via the communication link 150 to provide to the processor 120. As another example, the device 102 includes a transmitter 142B and a receiver 144B that are each coupled to the memory 122 and to the communication link 150. The transmitter 142B is configured to obtain data from the memory 122 for transmission via the communication link 150 to one or more components of the device 102. The receiver 144B is configured to receive data from one or more components of the device 102 via the communication link 150 to provide to the memory 122.

It should be understood that the processor 120 and the memory 122 are provided as illustrative examples of components of the device 102 that use transmitters and receivers to exchange data via the communication link 150, in other examples the device 102 can include one or more additional components, one or more different components, or a combination thereof, that are configured to use transmitters and receivers to exchange data via the communication link 150. In yet other examples, multiple devices can use transmitters and receivers to exchange data with each other via a communication link 150. In some examples, nodes of a network can use transmitters and receivers to exchange data with each other via a communication link 150.

A transmitter 142 includes a link encoder 132 and a receiver 144 includes a link decoder 134. For example, the transmitter 142A and the transmitter 142B include a link encoder 132A and a link encoder 132B, respectively, and the receiver 144A and the receiver 144B include a link decoder 134A and a link decoder 134B, respectively.

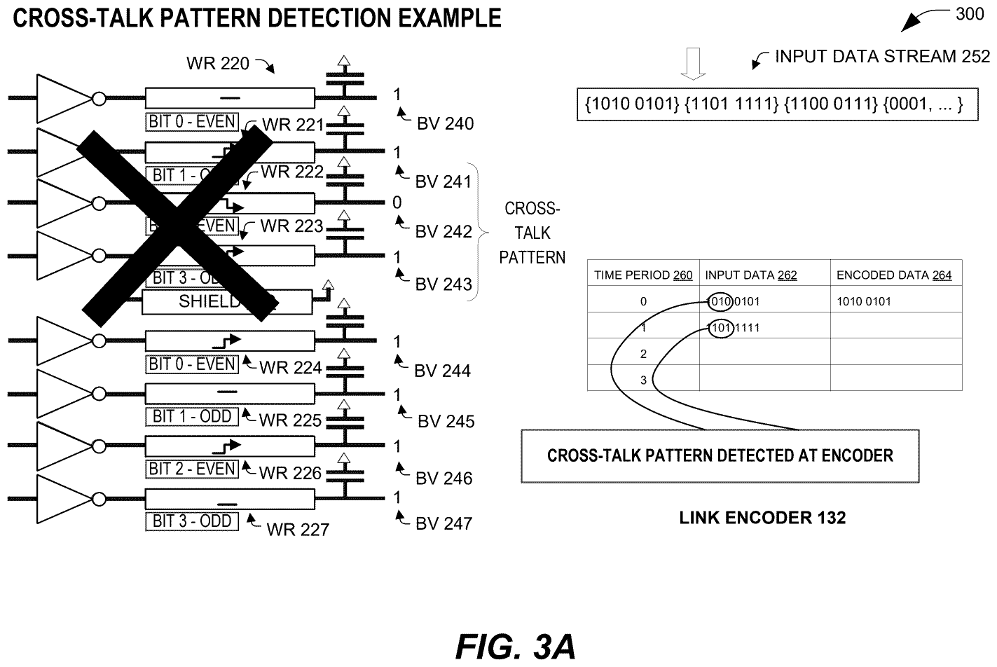

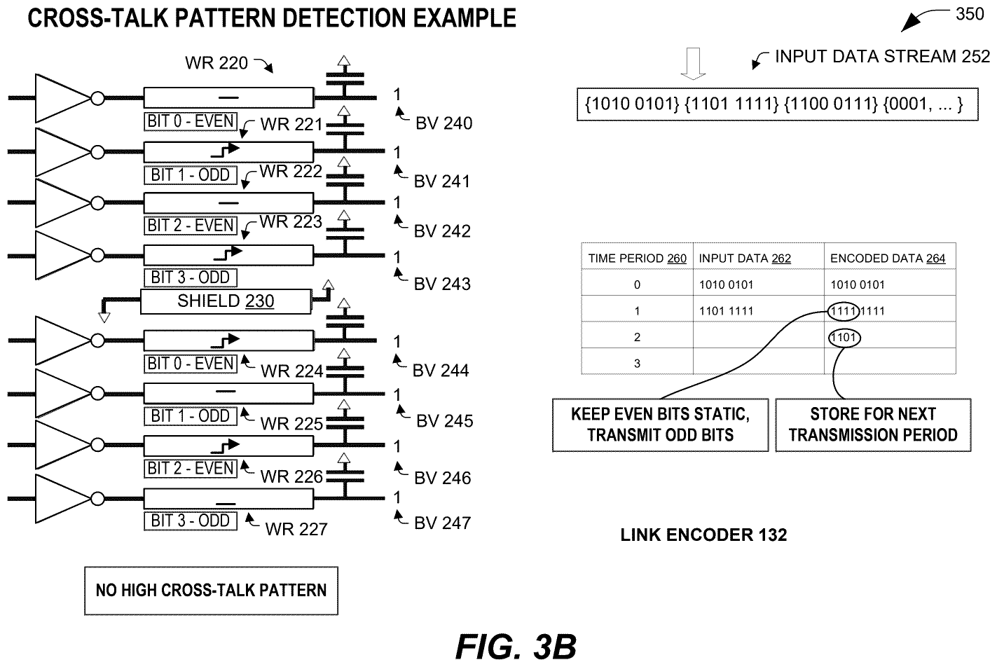

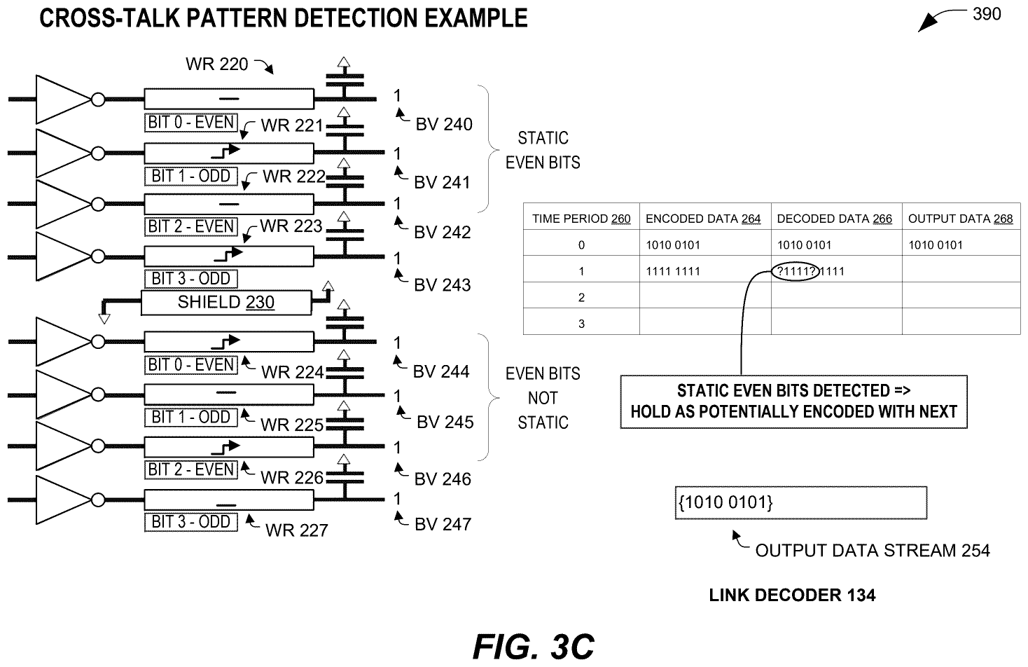

A transmitter 142 is configured to obtain a set of bit values to be sent via a set of wires of the communication link 150. A link encoder 132 is configured to determine, based on a transition pattern associated with the set of bit values, whether to send the set of bit values during a single transmission period or during multiple transmission periods. For example, the link encoder 132 is configured to, in response to determining that the transition pattern matches a cross-talk pattern, determine that the set of bit values are to be sent during multiple transmission periods, as further described with reference to FIG. 3A. The cross-talk pattern includes two adjacent bits transitioning in opposite directions.

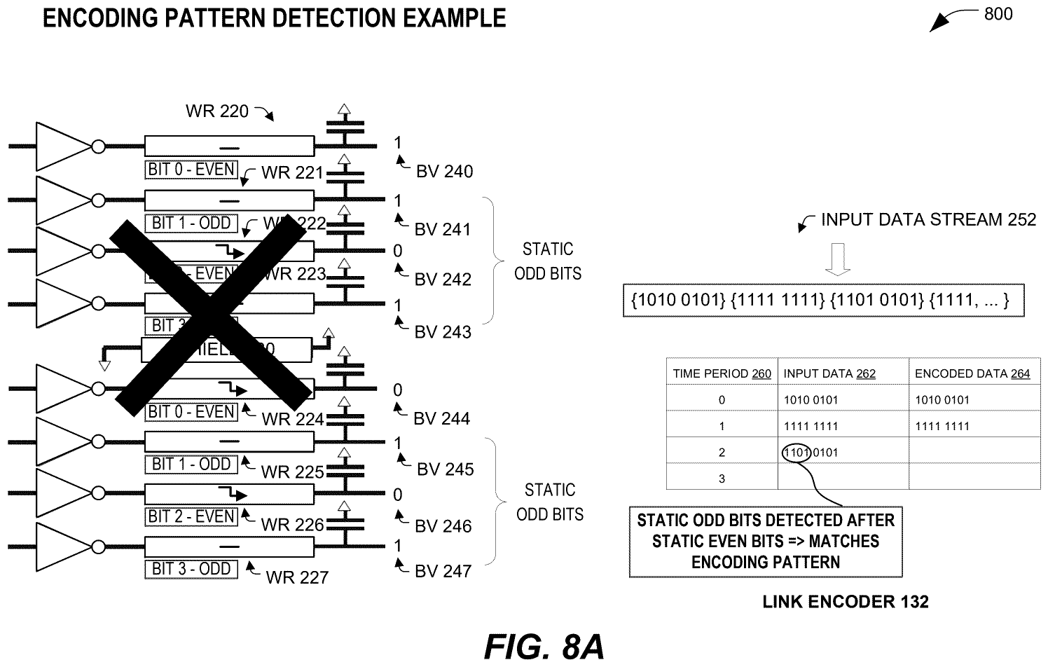

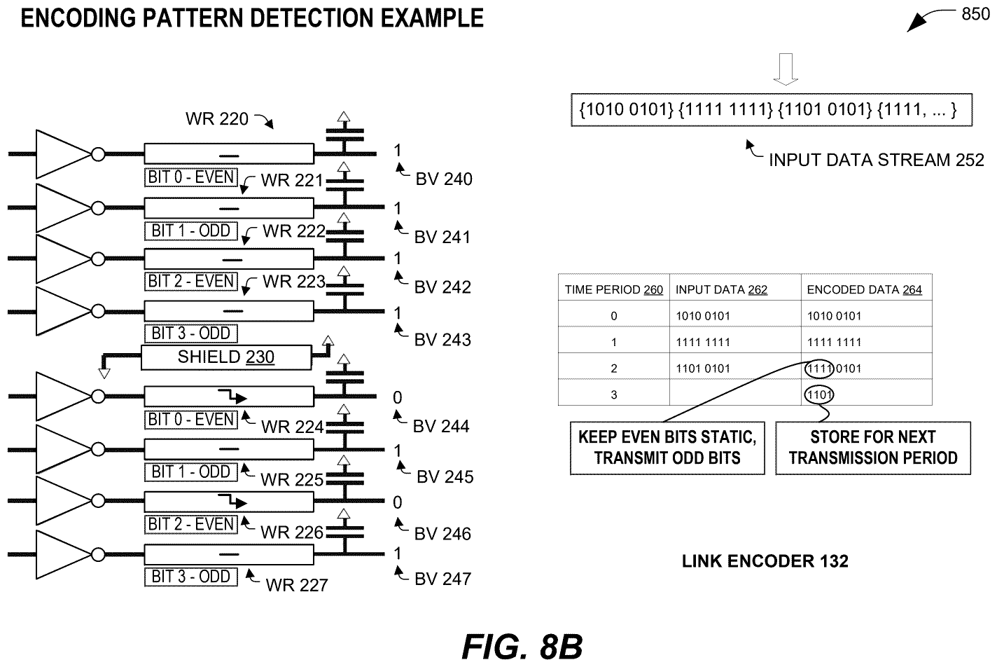

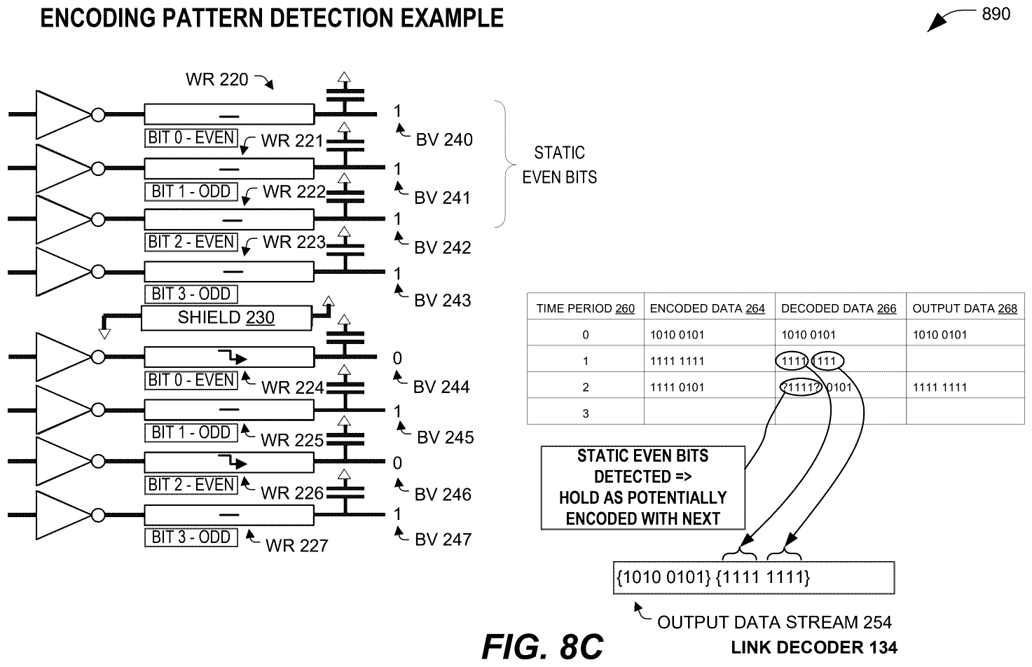

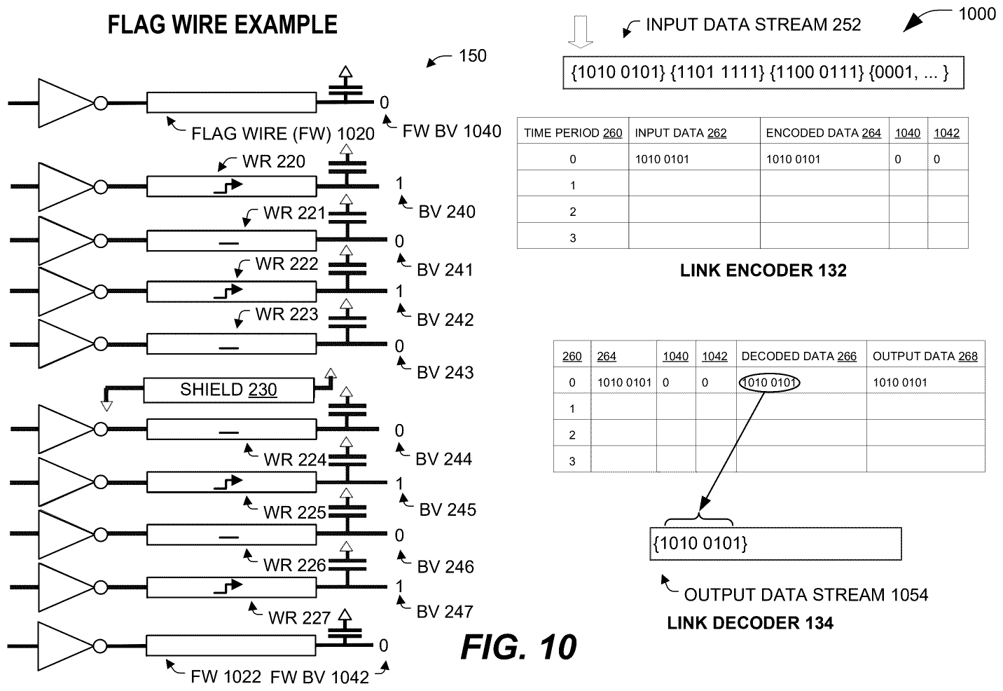

In a particular embodiment, the link encoder 132 is configured to, in response to determining that the transition pattern matches an encoding pattern associated with multiple transmission periods, determine that the set of bit values are to be sent during multiple transmission periods, as further described with reference to FIG. 8B. An encoding pattern associated with multiple transmission periods includes particular transition patterns associated with respective transmission periods. For example, an encoding pattern associated with two transmission periods includes a first transition pattern (e.g., static even bits) followed by a second transition pattern (e.g., static odd bits) in two consecutive transmission periods. As another example, an encoding pattern associated with four transmission periods includes a first transition pattern (e.g., a first subset of static bits) followed by a second transition pattern (e.g., a second subset of static bits) followed by a third transition pattern (e.g., a third subset of static bits) followed by a fourth transition pattern (e.g., a fourth subset of static bits) in four consecutive transmission periods. In this embodiment, the link encoder 132 is configured to, in response to determining that the transition pattern matches neither a cross-talk pattern nor an encoding pattern, determine that the set of bit values are to be sent during a single transmission period. In another particular embodiment, the link encoder 132 is configured to send a flag wire bit value via a flag wire of the communication link 150 indicating whether multiple transmission periods are being used to transmit a particular set of bit values, as further described with reference to FIG. 10. The flag wire is associated with the set of wires. In some examples, the link encoder 132 is configured to use a pre-determined count of multiple transmission periods and the flag wire bit value has a first value (e.g., 0) to indicate that a single transmission period is being used or a second value (e.g., 1) to indicate that the pre-determined count of multiple transmission periods are being used. In some examples, the set of wires is associated with a set of flag wires and a value of the set of flag wires indicates the count of transmission periods that are being used. To illustrate, two flag wires can be used to indicate whether 1, 2, 3, or 4 transmission periods are being used. In this embodiment, the link encoder 132 is configured to, based on determining whether the transition pattern matches a cross-talk pattern, determine whether the particular set of bit values are to be sent during a single transmission period or during multiple transmission periods. To illustrate, in this embodiment, the determination is independent of whether the transition pattern matches an encoding pattern. The transmitter 142 is configured to send the set of bit values based on the determination.

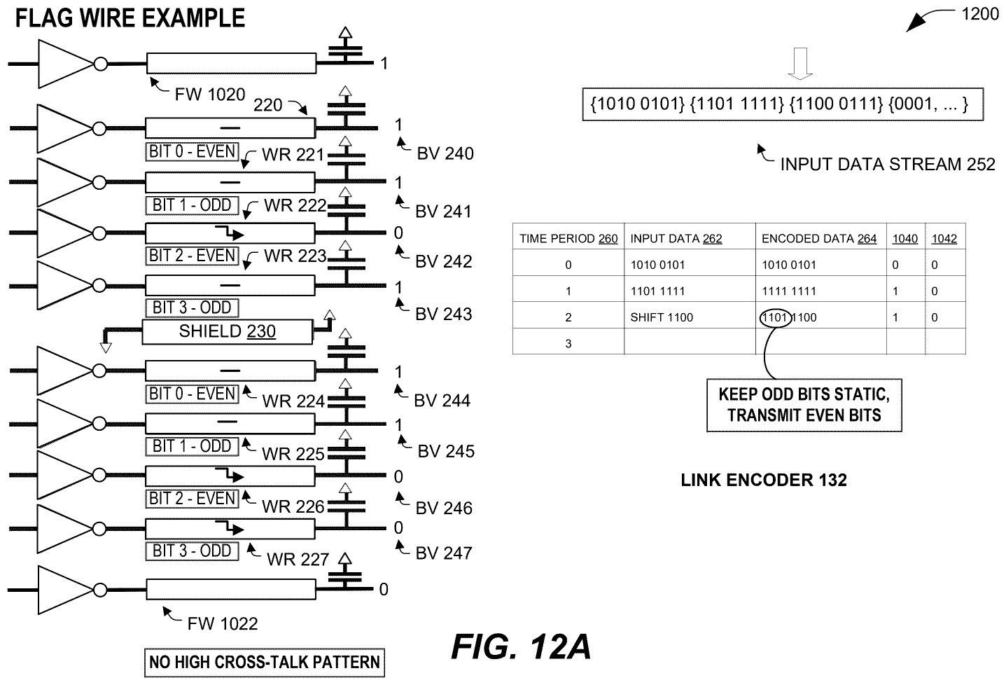

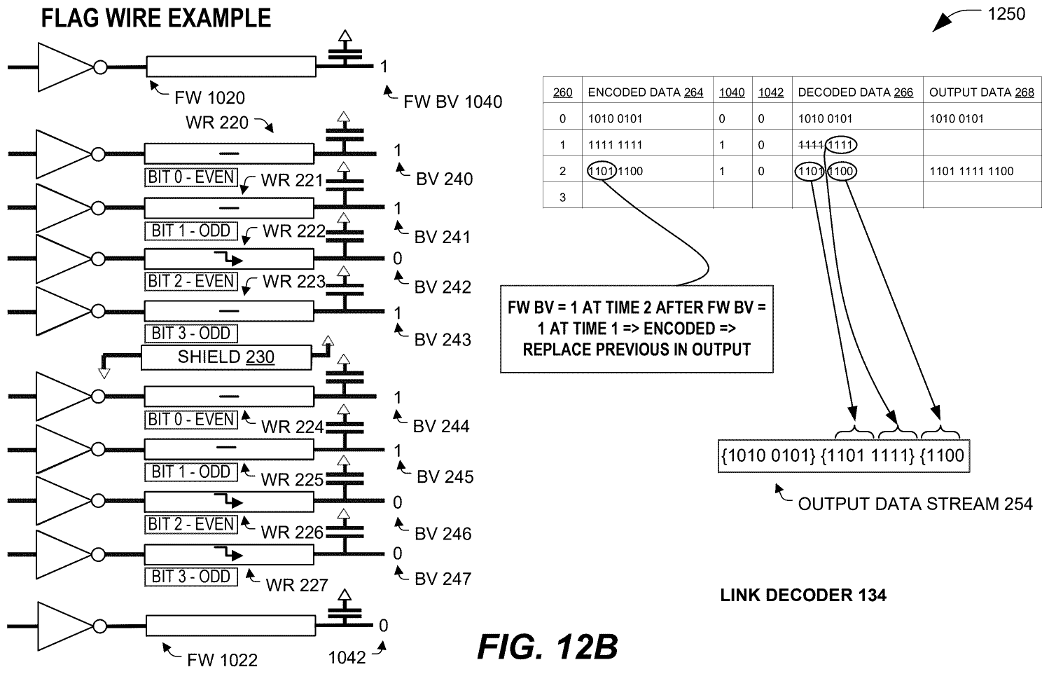

A link decoder 134 is configured to determine whether an encoding pattern is detected. In a particular embodiment, the link decoder 134 is configured to determine whether one or more encoding patterns associated with respective counts of multiple transmission periods are detected. In an example, a receiver 144 is configured to receive a first set of bit values during a first transmission period, a second set of bit values during a second transmission period, and a third set of bit values during a third transmission period via a set of wires of the communication link 150. In a particular aspect, a link decoder 134 is configured to, in response to determining that an encoding pattern associated with two transmission periods is detected, discard the second set of bit values and output the third set of bit values as decoded data, as further described with reference to FIG. 8C. In a particular aspect, the link decoder 134 is configured to, in response to determining that an encoding pattern associated with three transmission periods is detected, discard the first set of bit values, and the second set of bit values and output the third set of bit values as decoded data. In another embodiment, the receiver 144 is configured to receive a first flag wire value via a flag wire set concurrently with receiving the first set of bit values during the first transmission period, a second flag wire value via the flag wire set concurrently with receiving the second set of bit values during the second transmission period, and a third flag wire value via the flag wire set concurrently with receiving the third set of bit values during the third transmission period. The link decoder 134 is configured to, in response to determining that each of the second flag wire value (e.g., 1) and the third flag wire value (e.g., 1) indicates that two transmission periods are being used, discard the second set of bit values and output the third set of bit values as decoded data, as further described with reference to FIG. 12B. In another example, the link decoder 134 is configured to, in response to determining that each of the first flag wire value (e.g., 2), the second flag wire value (e.g., 2) and the third flag wire value (e.g., 2) indicates that three transmission periods are being used, discard the first set of bit values and the second set of bit values and output the third set of bit values as decoded data.

The system 100 thus provides a solution to a potential cross-talk problem by keeping a subset of wires static in each of the multiple transmission periods to avoid having two adjacent wires transitioning in opposite directions. For example, when two transmission periods are used, even wires are kept static in a first transmission period and odd wires are kept static in a second transmission period to avoid having two adjacent wires transitioning in opposite directions. Multiple transmission periods are selectively used so that a set of bits values that is associated with a transition pattern that does not match a cross-talk pattern, and in some embodiments does not match an encoding pattern, can be sent in a single transmission period to maintain throughput.

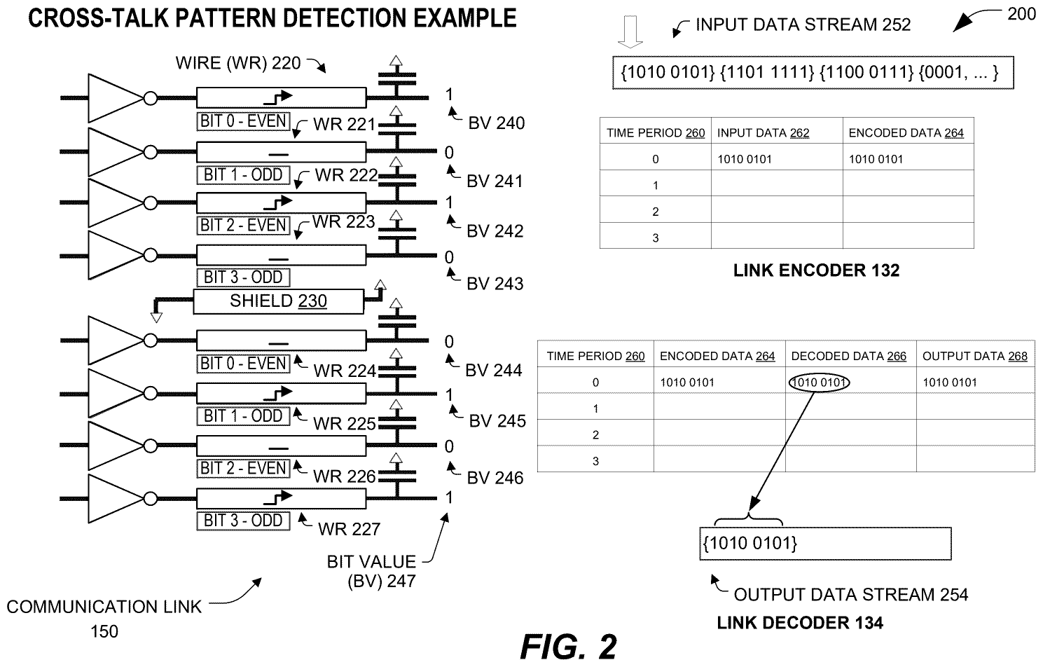

FIGS. 2-5B illustrate an example of operations at a link encoder 132 and a link decoder 134 when a cross-talk pattern is detected at the link encoder 132. FIG. 2 illustrates the link encoder 132 sending a first set of input bit values as a first set of encoded bit values during a first transmission period and a link decoder 134 receiving and outputting the first set of encoded bit values as decoded data. FIG. 3A illustrates the link encoder 132 determining that a transition pattern associated with a second set of input values matches a cross-talk pattern. FIG. 3B illustrates the link encoder 132 keeping even bits static and sending odd bits as a second set of encoded bit values during a second transmission period. FIG. 3C illustrates the link decoder 134 receiving the second set of encoded bit values and, based on detecting static even bits, holding the second set of encoded bit values as potentially encoded with next bit values to be received.

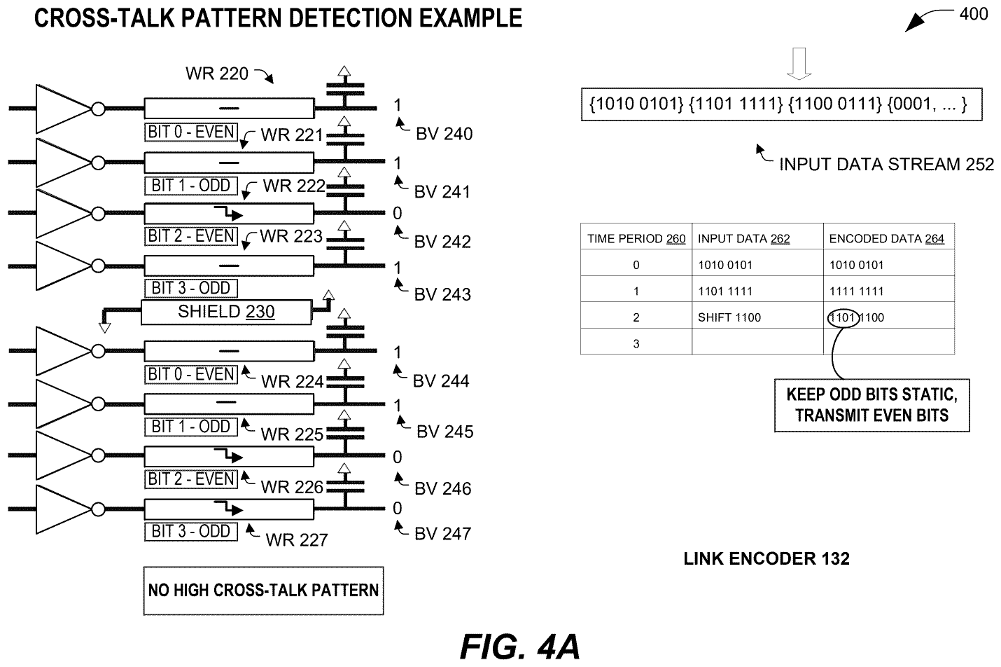

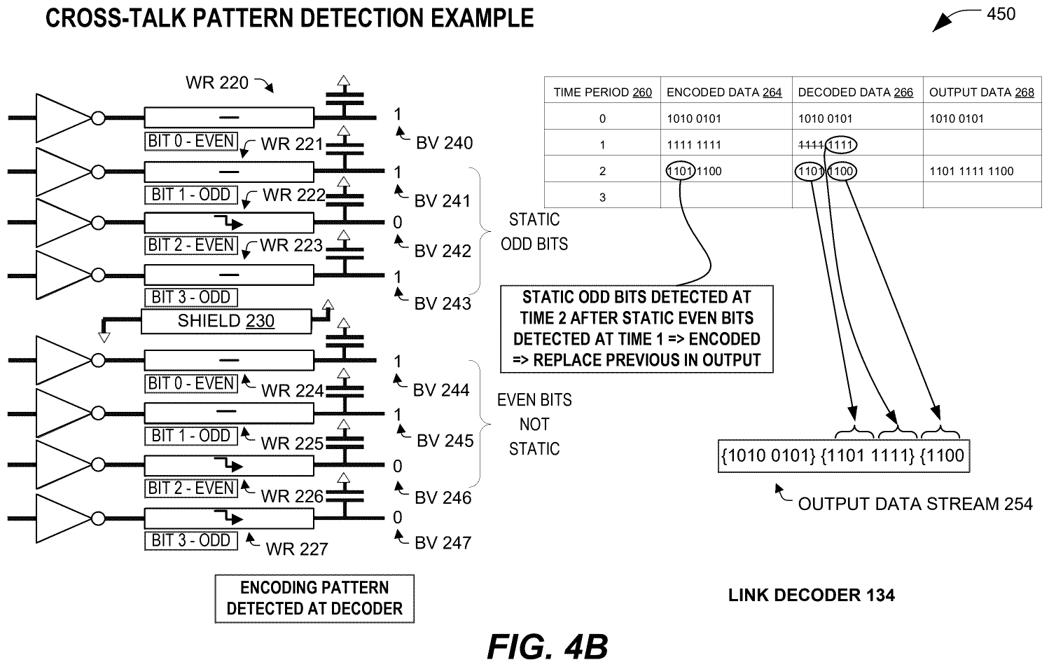

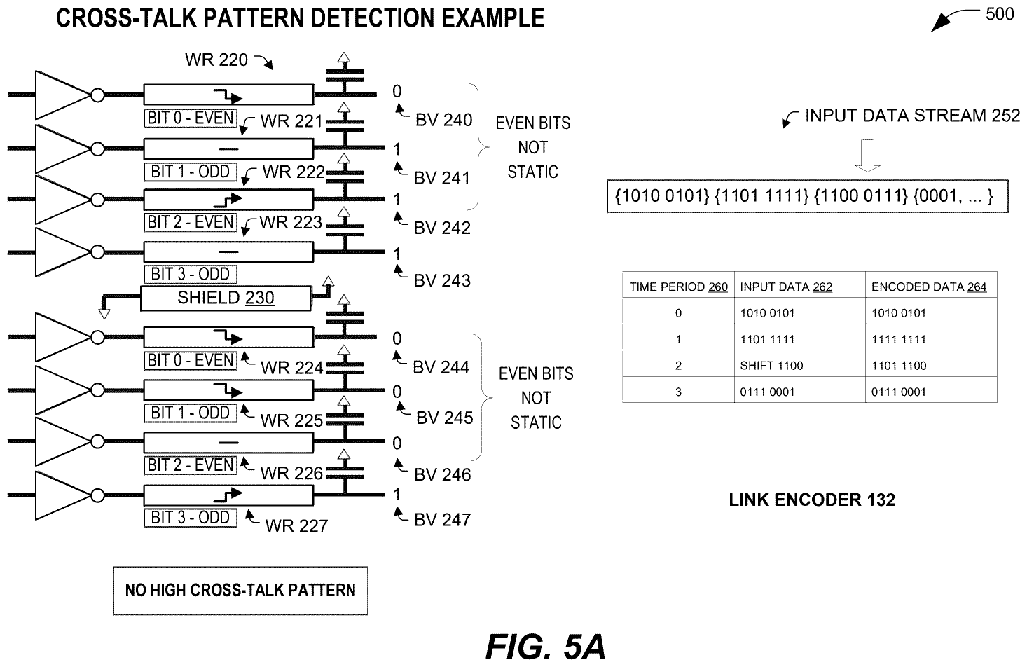

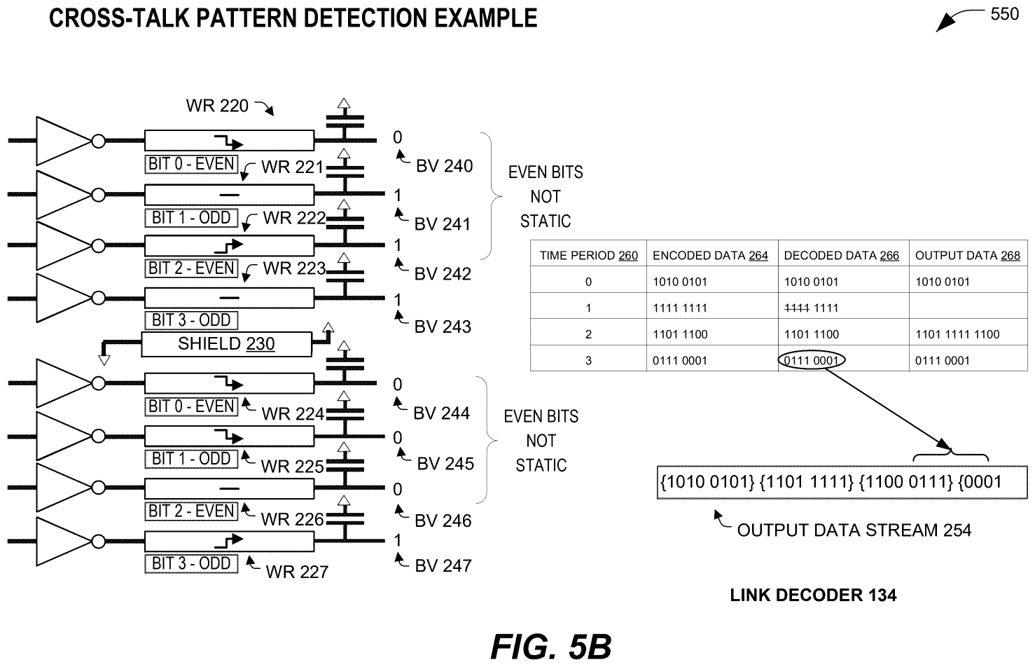

FIG. 4A illustrates the link encoder 132 keeping odd bits static and sending even bits as a third set of encoded bit values during a third transmission period. FIG. 4B illustrates the link decoder 134 receiving the third set of encoded bit values and, based on detecting static odd bits, discarding the second set of encoded bit values and outputting the third set of encoded bit values as decoded data. FIG. 5A illustrates the link encoder 132 determining that a transition pattern associated with a third set of input values does not match a cross-talk pattern and sending the third set of input values as a fourth set of encoded bit values in a fourth transmission period. FIG. 5B illustrates the link decoder 134 receiving the fourth set of encoded bit values and, based on determining that even bits are not static, outputting the fourth set of encoded bit values as decoded data.

Referring to FIG. 2, a diagram 200 is shown of an illustrative aspect of operations at a link encoder 132 and a link decoder 134 associated with a cross-talk pattern detection example, in accordance with some examples of the present disclosure.

The communication link 150 includes a first subset of wires (e.g., a wire 220, a wire 221, a wire 222, and a wire 223) and a second subset of wires (e.g., a wire 224, a wire 225, a wire 226, and a wire 227). In a particular embodiment, the first subset of wires and the second subset of wires are separated by a shield 230. For example, the shield 230 is between the wire 223 and the wire 224 and prevents a transition in either of the wire 223 or the wire 224 from having an effect on the other of the wire 223 or the wire 224. Having shields between each pair of wires of the communication link 150 can be costly in terms of available space and thus the shield 230 is used to separate subsets of wires.

The communication link 150 including two subsets of wires and each subset of wires including four wires is provided as an illustrative example, in other examples the communication link 150 can include fewer than two subsets of wires or more than two subsets of wires and a subset of wires can include fewer than four wires or more than four wires.

A transmitter 142 is configured to apply a voltage that is within a first voltage range or a second voltage range to a wire to send a first bit value (e.g., 0) or a second bit value (e.g., 1), respectively. A receiver 144 is configured to, based on detecting a voltage on a wire that is within the first voltage range or the second voltage range, receive the first bit value or the second bit value, respectively.

During operation, the link encoder 132 obtains an input data stream 252 for transmission via the communication link 150. In a particular example, the link encoder 132A obtains the input data stream 252 from the processor 120 to send to the memory 122. In another example, the link encoder 132B obtains the input data stream 252 from the memory 122 to send to the processor 120.

The link encoder 132 determines that a first set of bit values (e.g., 1010) and a second set of bit values (e.g., 0101) of the input data stream 252 are to be sent via the first subset of wires and the second subset of wires, respectively, during a time period 260 (e.g., 0) corresponding to a first transmission period.

The transmitter 142 transmits the first set of bit values (e.g., 1010) via the first subset of wires (e.g., the wires 220-223) and the second set of bit values (e.g., 0101) via the second subset of wires (e.g., the wires 224-227) as encoded data 264 during the time period 260 (e.g., 0) corresponding to the first transmission period. For example, the transmitter 142 sends a first bit value (e.g., 1) of the first set of bit values as a bit value 240 of the wire 220, a second bit value (e.g., 0) of the first set of bit values as a bit value 241 of the wire 221, a third bit value (e.g., 1) of the first set of bit values as a bit value 242 of the wire 222, and a fourth bit value (e.g., 0) of the first set of bit values as a bit value 243 of the wire 223. As another example, the transmitter 142 sends a first bit value (e.g., 0) of the second set of bit values as a bit value 244 of the wire 224, a second bit value (e.g., 1) of the second set of bit values as a bit value 245 of the wire 225, a third bit value (e.g., 0) of the second set of bit values as a bit value 246 of the wire 226, and a fourth bit value (e.g., 1) of the second set of bit values as a bit value 247 of the wire 227.

The receiver 144 receives the first set of bit values (e.g., 1010) via the first subset of wires (e.g., the wires 220-223) and the second set of bit values (e.g., 0101) via the second subset of wires (e.g., the wires 224-227) as the encoded data 264 during the time period 260 (e.g., 0) corresponding to the first transmission period. The link decoder 134 determines decoded data 266 (e.g., 1010 0101) based on the encoded data 264 (e.g., 1010 0101) and outputs the decoded data 266 as output data 268 (e.g., 1010 0101) of an output data stream 254. In a particular example, the link decoder 134 provides the output data stream 254 to the memory 122. In another example, the link decoder 134 provides the output data stream 254 to the processor 120.

Referring to FIG. 3A, a diagram 300 is shown of an illustrative aspect of operations at the link encoder 132 associated with cross-talk pattern detection example, in accordance with some examples of the present disclosure.

The link encoder 132 determines that a first set of bit values (e.g., 1101) and a second set of bit values (e.g., 1111) of the input data stream 252 are to be sent via the first subset of wires and the second subset of wires, respectively, during a time period 260 (e.g., 1) corresponding to a second transmission period that is subsequent to the first transmission period.

The link encoder 132 determines transition patterns associated with sets of bit values to be sent via subsets of wires of the communication link 150. For example, the link encoder 132 determines a first transition pattern (e.g., - \hat{ } v \hat{ }) associated with the first set of bit values (e.g., 1101) based on a comparison of the first set of bit values (e.g., 1101) to be sent and the first set of bit values (e.g., 1010) previously sent via the first subset of wires (e.g., the wires 220-223). As another example, the link encoder 132 determines a second transition pattern (e.g., \hat{ } - \hat{ } -) associated with the second set of bit values (e.g., 1111) to be sent and the second set of bit values (e.g., 0101) previously sent via the second subset of wires (e.g., the wires 224-227).

In a particular aspect, a static indicator (e.g., -) in a transition pattern indicates that a bit value on a wire remains the same between the previous transmission period and the next transmission period, an up-transition indicator (e.g., \hat{ }) in the transition pattern indicates a first bit value (e.g., 0) on a wire in the previous transmission period and a second bit value (e.g., 1) on the wire in the next transmission period, and a down-transition indicator (e.g., v) indicates the second bit value on a wire in the previous transmission period and the first bit value on the wire in the next transmission period. It should be understood that particular symbols representing particular indicators are provided as illustrative examples, in other examples another symbol can be used as an indicator. For example, in FIG. 3A, [symbol] is used as an example of the up-transition indicator and [symbol] is used as an example of the down-transition indicator.

The link encoder 132 determines whether any of the transition patterns match a cross-talk pattern. For example, the link encoder 132, in response to determining that the first transition pattern (e.g., - \hat{ } v \hat{ }) indicates at least two adjacent wires (e.g., the wires 221 and 222, as well as the wires 222 and 223) transitioning in opposite directions, determines that the first transition pattern matches a cross-talk pattern. As another example, the link encoder 132, in response to determining that the second transition pattern (e.g., \hat{ } - \hat{ } -) indicates that no adjacent wires transition in opposite directions, determines that the second transition pattern does not match a cross-talk pattern.

The link encoder 132, based on determining whether a transition pattern matches a cross-talk pattern, determines whether to send a corresponding set of bit values during a single transmission period or during two transmission periods. For example, the link encoder 132, in response to determining that the first transition pattern matches a cross-talk pattern, determines that the first set of bit values (e.g., 1101) are to be sent during two transmission periods. The link encoder 132, in response to determining that the second transition pattern does not match a cross-talk pattern, determines that the second set of bit values (e.g., 1111) are to be sent during one transmission period.

Referring to FIG. 3B, a diagram 350 of an illustrative aspect of operations at the link encoder 132 associated with the cross-talk pattern detection example, in accordance with some examples of the present disclosure is shown.

The transmitter 142, in response to determining that the first set of bit values (e.g., 1101) are to be sent during two transmission periods, as described with reference to FIG. 3A, sends alternate bit values of the first set of bit values (e.g., 1101) via the first subset of wires (e.g., the wires 220-223) during each of the two transmission periods. In an example, the first set of wires (e.g., the wires 220-223) includes even wires (e.g., the wires 220 and 222) and odd wires (e.g., the wires 221 and 223). The first set of bit values (e.g., 1101) includes even bit values (e.g., underlined ones of 1101) and odd bit values (e.g., underlined ones of 1101). It should be understood that “even” bit value and “odd” bit value refers to a position of a bit value within a set of bit values. Similarly, “even” wire and “odd” wire refers to a position of a wire within a subset of wires.

The transmitter 142, based on determining that the first set of bit values (e.g., 1101) are to be sent during two transmission periods, keeps the even wires (e.g., the wires 220 and 222) static and sends the odd bit values (e.g., underlined ones of 1101) via the odd wires (e.g., the wires 221 and 223) during a time period 260 (e.g. 1) corresponding to a second transmission period that is next after the first transmission period. The transmitter 142 also stores the first set of bit values (e.g., 1101) for a third transmission period that is next after the second transmission period.

Keeping the even wires (e.g., the wires 220 and 222) static corresponds to sending the same bit value (e.g., 1) using each of the wires 220 and 222 during a second transmission period (e.g., 1) as were sent during the first transmission period (e.g., 0). In the illustrated example, sending the odd bit values (e.g., underlined ones of 1101) via the odd wires (e.g., the wires 221 and 223) corresponds to sending the second bit value (e.g., 1) using each of the wires 221 and 223. The transmitter 142 thus sends a first set of encoded bit values (e.g., 1111) using the first subset of wires (e.g., the wires 220-223) during the time period 260 (e.g., 1) corresponding to the second transmission period. Since the first set of encoded bit values (e.g., 1111) includes static even bit values, there are no adjacent wires that transition in opposite directions and a transition pattern (e.g., - \hat{ } - \hat{ }) of the first set of encoded bit values does not match a cross-talk pattern.

In a particular embodiment, the transmitter 142, in response to determining that the second set of bit values (e.g., 1111) are to be transmitted during a single transmission period, as described with reference to FIG. 3A, sends the second set of bit values (e.g., 1111) using the second subset of wires (e.g., the wires 224-227) during the time period 260 (e.g., 1) corresponding to the second transmission period. Encoded data 264 sent during the second transmission period thus includes the first set of encoded bit values (e.g., 1111) and the second set of bit values (e.g., 1111).

Referring to FIG. 3C, a diagram 390 is shown of an illustrative aspect of operations at the link decoder 134 associated with the cross-talk pattern detection example, in accordance with some examples of the present disclosure.

The receiver 144 receives the encoded data 264 (e.g., 1111 1111) via the communication link 150 during the time period 260 (e.g., 1) corresponding to the second transmission period. For example, the receiver 144 receives a first set of bit values (e.g., 1111) via the first subset of wires (e.g., the wires 220-223) and receives a second set of bit values (e.g., 1111) via the second subset of wires (e.g., the wires 224-227).

The link decoder 134 determines transition patterns of the sets of bit values received via the subsets of wires. For example, the link decoder 134 determines a first detected transition pattern (e.g., - \hat{ } - \hat{ }) of the first set of bit values (e.g., 1111) based on a comparison of the first set of bit values (e.g., 1111) received during the second transmission period and a first set of bit values (e.g., 1010) received during the first transmission period via the first subset of wires (e.g., the wires 220-223). As another example, the link decoder 134 determines a second detected transition pattern (e.g., \hat{ } - \hat{ } -) of the second set of bit values (e.g., 1111) based on a comparison of the second set of bit values (e.g., 1111) received during the second transmission period and a second set of bit values (e.g., 0101) received during the first transmission period via the second subset of wires (e.g., the wires 224-227).

The link decoder 134, based on determining that the first detected transition pattern (e.g., - \hat{ } - \hat{ }) matches a first transition pattern (e.g., static even bit values) corresponding to a first stage of an encoding pattern, determines that the first transition pattern (e.g., static even bit values) is detected. The link decoder 134, based on determining that the first transition pattern (e.g., static even bit values) is detected, holds the first set of bit values (e.g., 1111) as tentatively decoded data 266 that is potentially encoded with next bit values to be received via the first subset of wires (e.g., the wires 220-223). The link decoder 134, based on determining that the second detected transition pattern (e.g., \hat{ } - \hat{ } -) does not match the first transition pattern (e.g., static even bit values), determines that the second set of bit values (e.g., 1111) are not potentially encoded. However, the link decoder 134 holds the second set of bit values (e.g., 1111) because the first set of bit values (e.g., 1111) that are prior to the second set of bit values are being held as potentially encoded. The link decoder 134 refrains from outputting the decoded data 266 (e.g., 1111 1111) as output data 268 during the time period 260 (e.g., 1) corresponding to the second transmission period.

Referring to FIG. 4A, a diagram 400 is shown of an illustrative aspect of operations at the link encoder 132 associated with the cross-talk pattern detection example, in accordance with some examples of the present disclosure.

The transmitter 142, in response to determining that stored first set of bit values (e.g., 1101) are to be sent during two transmission periods, as described with reference to FIG. 3A and that the next transmission period corresponds to a second one of the two transmission periods, keeps the odd wires (e.g., the wires 221 and 223) static and sends even bit values (e.g., underlined ones of 1101) via the even wires (e.g., the wires 220 and 222) during a time period 260 (e.g., 2) corresponding to the third transmission period.

The odd bit values were sent during the second transmission period. Keeping the odd wires (e.g., the wires 221 and 223) static and sending the even bit values via the even wires (e.g., the wires 220 and 222) corresponds to sending the first set of bit values (e.g., 1101) using the first subset of wires (e.g., the wires 220-223) during the third transmission period. Since the first set of bit values (e.g., 1101) includes static odd bit values, there are no adjacent wires that transition in opposite directions and a transition pattern (e.g., - - v-) of the first set of bit values does not match a cross-talk pattern.

The link encoder 132, instead of obtaining two sets of bit values from the input data stream 252 to send during the next transmission period, shifts the input data stream 252 by one set and obtains a single set of bit values (e.g., 1100) as a second set of bit values to be transmitted via the second subset of wires (e.g., the wires 224-227).

The link encoder 132 determines a second transition pattern (e.g., - - v v) associated with the second set of bit values (e.g., 1100) based on a comparison of the second set of bit values to be sent and a second set of bit values (e.g., 1111) previously sent via the second subset of wires (e.g., the wires 224-227). The link encoder 132, based on determining that the second transition pattern does not match a cross-talk pattern, determines that the second set of bit values (e.g., 1100) are to be sent using the second subset of wires (e.g., the wires 224-227) in a single transmission period (e.g., the third transmission period). Encoded data 264 sent during the third transmission period thus includes the first set of bit values (e.g., 1101) and the second set of bit values (e.g., 1100).

Referring to FIG. 4B, a diagram 450 is shown of an illustrative aspect of operations at the link decoder 134 associated with the cross-talk pattern detection example, in accordance with some examples of the present disclosure.

The receiver 144 receives the encoded data 264 (e.g., 1101 1100) via the communication link 150 during the time period 260 (e.g., 2) corresponding to the third transmission period. For example, the receiver 144 receives a first set of bit values (e.g., 1101) via the first subset of wires (e.g., the wires 220-223) and receives a second set of bit values (e.g., 1100) via the second subset of wires (e.g., the wires 224-227).

The link decoder 134 determines transition patterns associated with the sets of bit values received via the subsets of wires. For example, the link decoder 134 determines a first detected transition pattern (e.g., - - v -) associated with the first set of bit values (e.g., 1101) based on a comparison of the first set of bit values (e.g., 1101) received during the third transmission period and a first set of bit values (e.g., 1111) received during the second transmission period via the first subset of wires (e.g., the wires 220-223). As another example, the link decoder 134 determines a second detected transition pattern (e.g., - - v v) associated with the second set of bit values (e.g., 1100) based on a comparison of the second set of bit values (e.g., 1100) received during the third transmission period and a second set of bit values (e.g., 1111) received during the second transmission period via the second subset of wires (e.g., the wires 224-227).

The link decoder 134 determines that the first detected transition pattern (e.g., - - v -) matches a second transition pattern (e.g., static odd bit values) corresponding to a second stage of an encoding pattern and determines that the second transition pattern (e.g., static odd bit values) is detected. The link decoder 134, based on determining that the second transition pattern (e.g., static odd bit values) is detected during the third transmission period subsequent to the first transition pattern (e.g., static even bit values) during the second transmission period, as described with reference to FIG. 3C, determines that an encoding pattern is detected. The link decoder 134, in response to determining that an encoding pattern is detected, discards the first set of bit values (e.g., 1111) that were held over from the second transmission period, and outputs the first set of bit values (e.g., 1101) received during the third transmission period as decoded data 266 in the output data stream 254. The link decoder 134, in response to determining that the first set of bit values (e.g., 1101) have replaced the first set of bit values (e.g., 1111) that were held over, outputs the second set of bit values (e.g., 1111) from the decoded data 266 that was held over from the second transmission period in the output data stream 254.

The link decoder 134, in response to determining that there is no data held over and that the second detected transition pattern (e.g., - - v v) does not match the first transition pattern (e.g., static even bits) corresponding to the first stage of an encoding pattern, outputs the second set of bit values (e.g., 1100) as decoded data 266 in the output data stream 254 during the third transmission period. Output data 268 of the third transmission period thus includes the first set of bit values (e.g., 1101) received during the third transmission period, the second set of bit values (e.g., 1111) received during the second transmission period, and the second set of bit values (e.g., 1100) received during the third transmission period.

Referring to FIG. 5A, a diagram 500 is shown of an illustrative aspect of operations at the link encoder 132 associated with the cross-talk pattern detection example, in accordance with some examples of the present disclosure.

The link encoder 132 determines that a first set of bit values (e.g., 0111) and a second set of bit values (e.g., 0001) of the input data stream 252 are to be sent via the first subset of wires and the second subset of wires, respectively, during a time period 260 (e.g., 3) corresponding to a fourth transmission period that is subsequent to the third transmission period.

The link encoder 132 determines transition patterns associated with sets of bit values to be sent via subsets of wires of the communication link 150. For example, the link encoder 132 determines a first transition pattern (e.g., v - \hat{ } -) associated with the first set of bit values (e.g., 0111) based on a comparison of the first set of bit values (e.g., 0111) to be sent and the first set of bit values (e.g., 1101) previously sent via the first subset of wires (e.g., the wires 220-223). As another example, the link encoder 132 determines a second transition pattern (e.g., v v - \hat{ }) associated with the second set of bit values (e.g., 0001) to be sent and the second set of bit values (e.g., 1100) previously sent via the second subset of wires (e.g., the wires 224-227).

The link encoder 132 determines whether any of the transition patterns match a cross-talk pattern. For example, the link encoder 132, in response to determining that the first transition pattern (e.g., v - \hat{ } -) indicates that no adjacent wires transition in opposite directions, determines that the first transition pattern does not match a cross-talk pattern. As another example, the link encoder 132, in response to determining that the second transition pattern (e.g., v v - \hat{ }) indicates that no adjacent wires transition in opposite directions, determines that the second transition pattern does not match a cross-talk pattern.

The link encoder 132, based on determining whether a transition pattern matches a cross-talk pattern, determines whether to send a corresponding set of bit values during a single transmission period or during two transmission periods. For example, the link encoder 132, in response to determining that the first transition pattern does not match a cross-talk pattern, determines that the first set of bit values (e.g., 0111) are to be sent during a single transmission period. As another example, the link encoder 132, in response to determining that the second transition pattern does not match a cross-talk pattern, determines that the second set of bit values (e.g., 0001) are to be sent during a single transmission period.

The transmitter 142 sends the sets of bit values based on the determination. For example, the transmitter 142, in response to determining that the first set of bit values (e.g., 0111) are to be sent during a single transmission period, sends the first set of bit values (e.g., 0111) using the first subset of wires (e.g., the wires 220-223) during the time period 260 (e.g., 3) corresponding to the fourth transmission period. As another example, the transmitter 142, in response to determining that the second set of bit values (e.g., 0001) are to be sent during a single transmission period, sends the second set of bit values (e.g., 0001) using the second subset of wires (e.g., the wires 224-227) during the time period 260 (e.g., 3) corresponding to the fourth transmission period. Encoded data 264 sent during the fourth transmission period thus includes the first set of bit values (e.g., 0111) and the second set of bit values (e.g., 0001).

Referring to FIG. 5B, a diagram 550 is shown of an illustrative aspect of operations at the link decoder 134 associated with the cross-talk pattern detection example, in accordance with some examples of the present disclosure.

The receiver 144 receives the encoded data 264 (e.g., 0111 0001) via the communication link 150 during the time period 260 (e.g., 3) corresponding to the fourth transmission period. For example, the receiver 144 receives a first set of bit values (e.g., 0111) via the first subset of wires (e.g., the wires 220-223) and receives a second set of bit values (e.g., 0001) via the second subset of wires (e.g., the wires 224-227).

The link decoder 134 determines transition patterns of the sets of bit values received via the subsets of wires. For example, the link decoder 134 determines a first detected transition pattern (e.g., v - \hat{ } -) associated with the first set of bit values (e.g., 0111) based on a comparison of the first set of bit values (e.g., 0111) received during the fourth transmission period and a first set of bit values (e.g., 1101) received during the third transmission period via the first subset of wires (e.g., the wires 220-223). As another example, the link decoder 134 determines a second detected transition pattern (e.g., v v - \hat{ }) associated with the second set of bit values (e.g., 0001) based on a comparison of the second set of bit values (e.g., 0001) received during the fourth transmission period and a second set of bit values (e.g., 1100) received during the third transmission period via the second subset of wires (e.g., the wires 224-227).

The link decoder 134, based on determining that the first detected transition pattern (e.g., v - \hat{ } -) does not match a first transition pattern (e.g., static even bit values) corresponding to a first stage of an encoding pattern, determines that the first set of bit values (e.g., 0111) are not potentially encoded. Similarly, the link decoder 134, based on determining that the second detected transition pattern (e.g., v v - \hat{ }) does not match the first transition pattern (e.g., static even bit values), determines that the second set of bit values (e.g., 0001) are not potentially encoded. Decoded data 266 for the time period 260 (e.g., 3) corresponding to the fourth transmission period thus includes the first set of bit values (e.g., 0111) and the second set of bit values (e.g., 0001). The link decoder 134 outputs the decoded data 266 as output data 268 (e.g., 0111 0001) of an output data stream 254. Sending the first set of bit values and the second set of bit values during a single transmission period has the advantage of maintaining throughput when corresponding transition patterns do not match a cross-talk pattern and sending the sets of bit values in the single transmission period is less likely to cause cross-talk related errors.

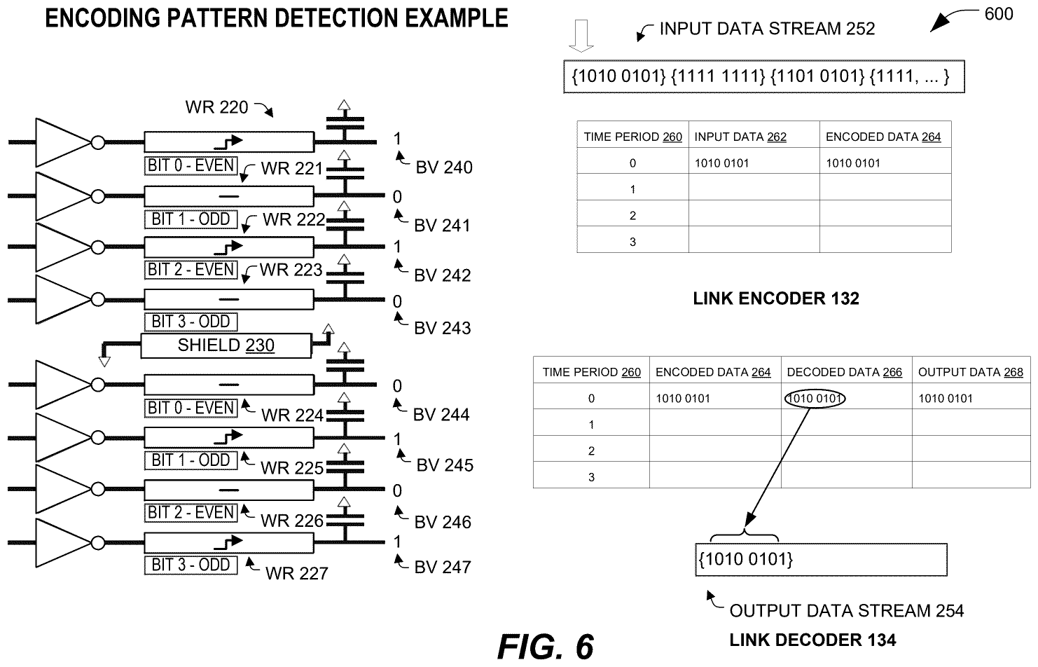

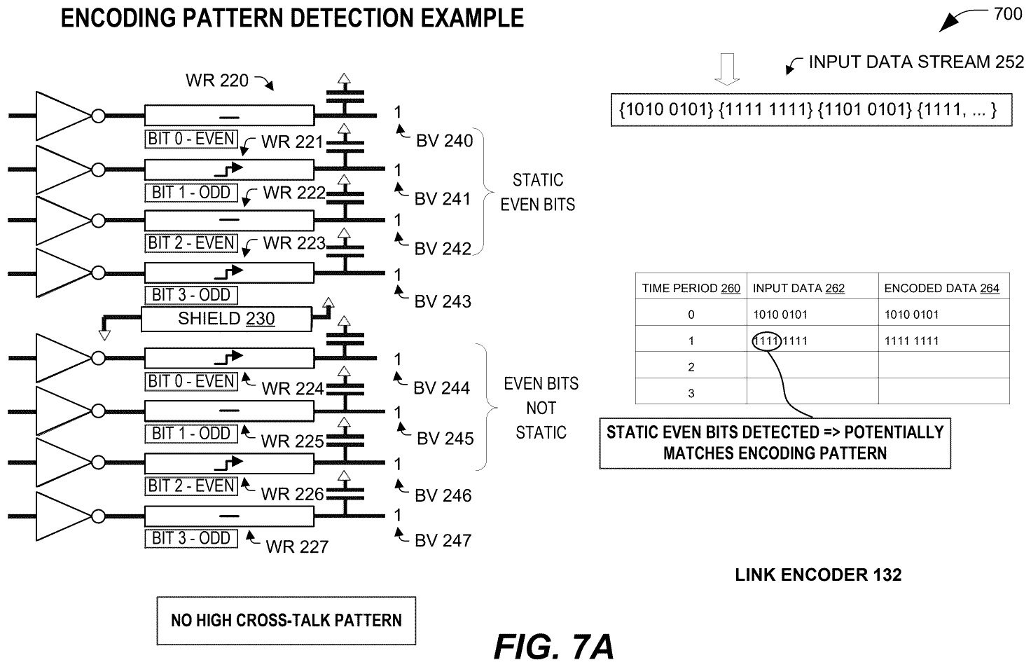

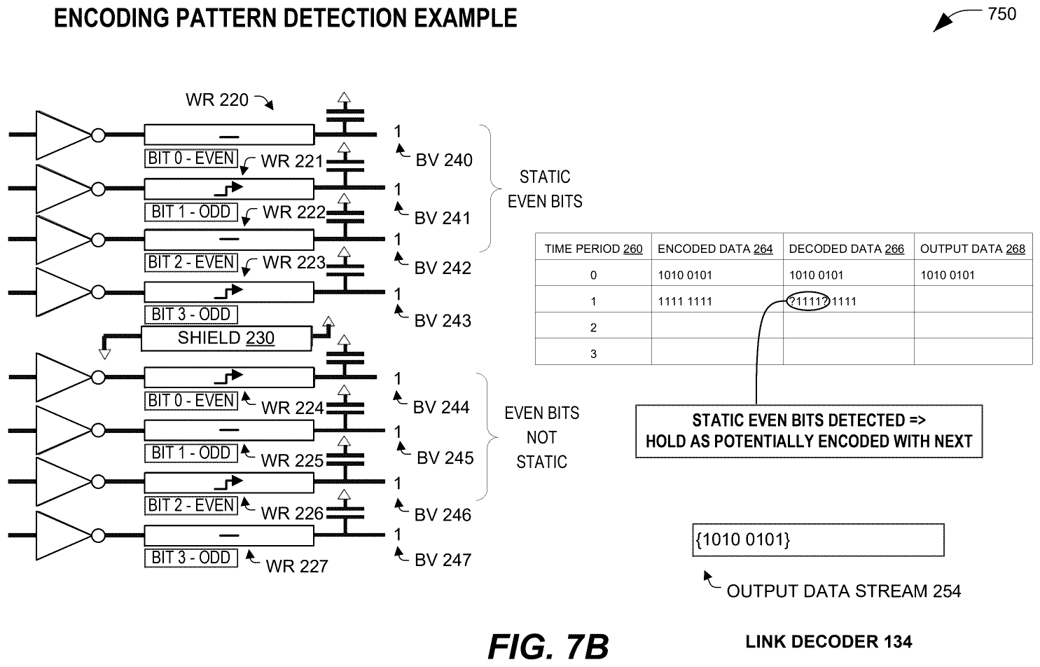

FIGS. 6-9B illustrate an example of operations at a link encoder 132 and a link decoder 134 when an encoding pattern is detected at the link encoder 132. FIG. 6 illustrates the link encoder 132 sending a first set of input bit values as a first set of encoded bit values during a first transmission period and a link decoder 134 receiving and outputting the first set of encoded bit values as decoded data. FIG. 7A illustrates the link encoder 132 determining that static even bits are detected that could potentially match an encoding pattern and sends a second set of input values as a second set of encoded bit values during a second transmission period. FIG. 7B illustrates the link decoder 134 receiving the second set of encoded bit values and, based on detecting static even bits, holding the second set of encoded bit values as potentially encoded.

FIG. 8A illustrates the link encoder 132, based on determining that static odd bits are detected, determine that an encoding pattern is detected and that a third set of input values is to be sent in two transmission periods. FIG. 8B illustrates the link encoder 132 keeping even bits static and sending odd bits as a third set of encoded bit values. FIG. 8C illustrates the link decoder 134 receiving the third set of encoded bit values and, based on detecting static even bits, holding the third set of encoded bit values as potentially encoded and outputting the second set of encoded bit values as decoded data.

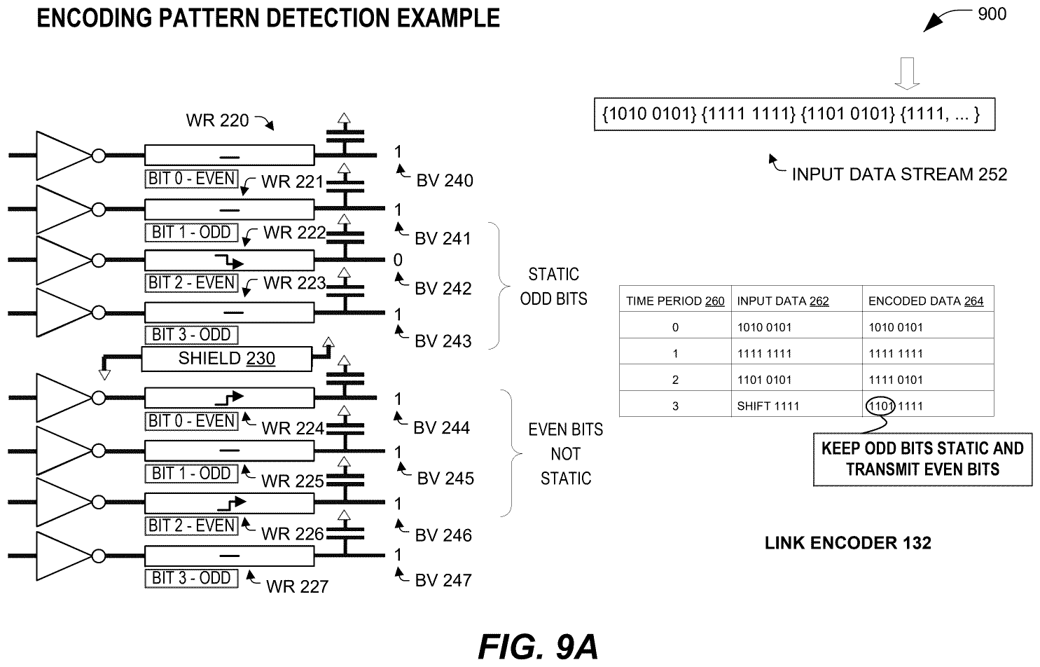

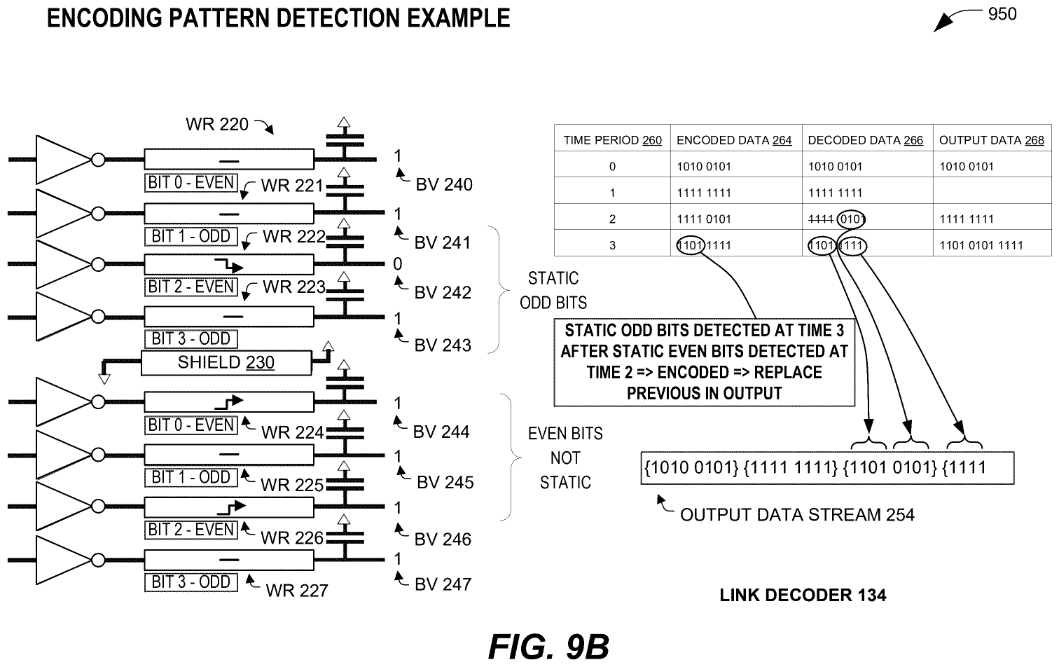

FIG. 9A illustrates the link encoder 132 keeping odd bits static and sending even bits as a fourth set of encoded bit values. FIG. 9B illustrates the link decoder 134 receiving the fourth set of encoded bit values and, based on detecting static odd bits, discarding the third set of encoded bit values and outputting the fourth set of encoded bit values as decoded data.

Referring to FIG. 6, a diagram 600 is shown of an illustrative aspect of operations at a link encoder 132 and a link decoder 134 associated with an encoding pattern detection example, in accordance with some examples of the present disclosure.

The link encoder 132 and the link decoder 134 perform similar operations as described with reference to FIG. 2. For example, the link encoder 132 obtains an input data stream 252 for transmission via the communication link 150. The link encoder 132 determines that a first set of bit values (e.g., 1010) and a second set of bit values (e.g., 0101) of the input data stream 252 are to be sent via the first subset of wires and the second subset of wires, respectively, during a time period 260 (e.g., 0) corresponding to a first transmission period.

The transmitter 142 transmits the first set of bit values (e.g., 1010) via the first subset of wires (e.g., the wires 220-223) and the second set of bit values (e.g., 0101) via the second subset of wires (e.g., the wires 224-227) as encoded data 264 during the time period 260 (e.g., 0) corresponding to the first transmission period.

The receiver 144 receives the first set of bit values (e.g., 1010) via the first subset of wires (e.g., the wires 220-223) and the second set of bit values (e.g., 0101) via the second subset of wires (e.g., the wires 224-227) as the encoded data 264 during the time period 260 (e.g., 0) corresponding to the first transmission period. The link decoder 134 determines decoded data 266 (e.g., 1010 0101) based on the encoded data 264 (e.g., 1010 0101) and outputs the decoded data 266 as output data 268 (e.g., 1010 0101) of an output data stream 254.

Referring to FIG. 7A, a diagram 700 is shown of an illustrative aspect of operations at the link encoder 132 associated with the encoding pattern detection example, in accordance with some examples of the present disclosure.

The link encoder 132 determines that a first set of bit values (e.g., 1111) and a second set of bit values (e.g., 1111) of the input data stream 252 are to be sent via the first subset of wires and the second subset of wires, respectively, during a time period 260 (e.g., 1) corresponding to a second transmission period that is subsequent to the first transmission period.

The link encoder 132 determines transition patterns associated with sets of bit values to be sent via subsets of wires of the communication link 150. For example, the link encoder 132 determines a first detected transition pattern (e.g., - \hat{ } - \hat{ }) associated with the first set of bit values (e.g., 1111) based on a comparison of the first set of bit values (e.g., 1111) to be sent and the first set of bit values (e.g., 1010) previously sent via the first subset of wires (e.g., the wires 220-223). As another example, the link encoder 132 determines a second detected transition pattern (e.g., \hat{ } - \hat{ } -) associated with the second set of bit values (e.g., 1111) to be sent and the second set of bit values (e.g., 0101) previously sent via the second subset of wires (e.g., the wires 224-227).

The link encoder 132 determines that neither the first detected transition pattern nor the second detected transition pattern matches a cross-talk pattern. The link encoder 132, in response to determining that the cross-talk pattern is not detected, determines whether a first transition pattern (e.g., static even bits) corresponding to a first stage of an encoding pattern is detected. For example, the link encoder 132 determines that the first detected transition pattern (e.g., - \hat{ } - \hat{ }) matches the first transition pattern (e.g., static even bits) and that the second detected transition pattern (e.g., \hat{ } - \hat{ } -) does not match the first transition pattern.

The link encoder 132, based on determining that the first detected transition pattern matches the first transition pattern (e.g., static even bits) corresponding to a first stage of an encoding pattern, determines that a next set of bit values to be transmitted after the first set of bit values could potentially match an encoding pattern.

The link encoder 132, in response to determining that each of the first detected transition pattern and the second detected transition pattern do not match a cross-talk pattern, determines that the first set of bit values and the second set of bit values are to be transmitted during a single transmission period. The transmitter 142 sends the first set of bit values (e.g., 1111) and the second set of bit values (e.g., 1111) using the first subset of wires (e.g., the wires 220-223) and the second subset of wires (e.g., the wires 224-227), respectively, during the time period 260 (e.g., 1) corresponding to the second transmission period. Encoded data 264 sent during the second transmission period thus includes the first set of encoded bit values (e.g., 1111) and the second set of bit values (e.g., 1111).

Referring to FIG. 7B, a diagram 750 is shown of an illustrative aspect of operations at the link decoder 134 associated with the encoding talk pattern detection example, in accordance with some examples of the present disclosure.

The receiver 144 and link decoder 134 perform one or more operations similar to operations described with reference to FIG. 3C. For example, the receiver 144 receives the encoded data 264 (e.g., 1111 1111) via the communication link 150 during the time period 260 (e.g., 1) corresponding to the second transmission period.

The link decoder 134 determines transition patterns associated with the sets of bit values received via the subsets of wires. For example, the link decoder 134 determines a first detected transition pattern (e.g., - \hat{ } - \hat{ }) associated with the first set of bit values (e.g., 1111) and a second detected transition pattern (e.g., \hat{ } - \hat{ } -) associated with the second set of bit values (e.g., 1111).

The link decoder 134, based on determining that the first detected transition pattern (e.g., - \hat{ } - \hat{ }) matches a first transition pattern (e.g., static even bit values) corresponding to a first stage of an encoding pattern, determines that the first transition pattern (e.g., static even bit values) is detected. The link decoder 134, based on determining that the first transition pattern (e.g., static even bit values) is detected, holds the first set of bit values (e.g., 1111) as tentatively decoded data 266 that is potentially encoded with next bit values to be received via the first subset of wires (e.g., the wires 220-223). The link decoder 134, based on determining that the second detected transition pattern (e.g., \hat{ } - \hat{ } -) does not match the first transition pattern (e.g., static even bit values), determines that the second set of bit values (e.g., 1111) are not potentially encoded. However, the link decoder 134 holds the second set of bit values (e.g., 1111) because the first set of bit values (e.g., 1111) that are prior to the second set of bit values are being held as potentially encoded. The link decoder 134 refrains from outputting the decoded data 266 (e.g., 1111 1111) as output data 268 during the time period 260 (e.g., 1) corresponding to the second transmission period.

Referring to FIG. 8A, a diagram 800 is shown of an illustrative aspect of operations at the link encoder 132 associated with the encoding pattern detection example, in accordance with some examples of the present disclosure.

The link encoder 132 determines that a first set of bit values (e.g., 1101) and a second set of bit values (e.g., 0101) of the input data stream 252 are to be sent via the first subset of wires and the second subset of wires, respectively, during a time period 260 (e.g., 2) corresponding to a third transmission period that is subsequent to the second transmission period.

The link encoder 132 determines transition patterns associated with sets of bit values to be sent via subsets of wires of the communication link 150. For example, the link encoder 132 determines a first detected transition pattern (e.g., - - v -) associated with the first set of bit values (e.g., 1101) based on a comparison of the first set of bit values (e.g., 1101) to be sent and the first set of bit values (e.g., 1111) previously sent via the first subset of wires (e.g., the wires 220-223). As another example, the link encoder 132 determines a second detected transition pattern (e.g., v - v -) associated with the second set of bit values (e.g., 0101) to be sent and the second set of bit values (e.g., 1111) previously sent via the second subset of wires (e.g., the wires 224-227).

The link encoder 132 determines that neither the first detected transition pattern nor the second detected transition pattern matches a cross-talk pattern. The link encoder 132, in response to determining that the cross-talk pattern is not detected and that a first detected transition pattern associated with a first set of bit values (e.g., 1111) previously sent via the wires 220-223 matched a first transition pattern (e.g., static even bits) corresponding to a first stage of an encoding pattern, determines whether the first detected transition pattern (e.g., - - v -) associated with the first set of bit values (e.g., 1101) matches a second transition pattern (e.g., static odd bits) corresponding to a second stage of an encoding pattern. The link encoder 132, in response to determining that the first detected transition pattern (e.g., - - v -) matches the second transition pattern (e.g., static odd bits) corresponding to the second stage of the encoding pattern, determines that the encoding pattern is detected and that the first set of bit values (e.g., 1101) are to be transmitted during two transmission periods.

The link encoder 132, in response to determining that the second detected transition pattern (e.g., v - v -) does not match a cross-talk pattern, that a second detected transition pattern associated with a second set of bit values (e.g., 1111) previously sent via the wires 224-227 did not match a first transition pattern (e.g., static even bits) corresponding to a first stage of an encoding pattern, determines whether the second detected transition pattern (e.g., v - v -) of the second set of bit values (e.g., 0101) matches a first transition pattern (e.g., static even bits) corresponding to a first stage of an encoding pattern. The link encoder 132, in response to determining that the second detected transition pattern (e.g., v - v -) does not match a cross-talk pattern, that a second detected transition pattern associated with a second set of bit values (e.g., 1111) previously sent via the wires 224-227 did not match a first transition pattern (e.g., static even bits) corresponding to a first stage of an encoding pattern, and that the second detected transition pattern (e.g., v - v -) of the second set of bit values (e.g., 0101) does not match a first transition pattern (e.g., static even bits) corresponding to a first stage of an encoding pattern, determines that the second set of bit values (e.g., 0101) are to be sent during a single transmission period.

Referring to FIG. 8B, a diagram 850 is shown of an illustrative aspect of operations at the link encoder 132 associated with the encoding pattern detection example, in accordance with some examples of the present disclosure.

The link encoder 132 and the transmitter 142 perform one or more operations similar to operations described with reference to FIG. 3B. For example, the link encoder 132, in response to determining that the first set of bit values (e.g., 1101) are to be sent during two transmission periods, as described with reference to FIG. 8A, sends alternate bit values of the first set of bit values (e.g., 1101) via the first subset of wires (e.g., the wires 220-223) during each of the two transmission periods.

The transmitter 142, based on determining that the first set of bit values (e.g., 1101) are to be sent during two transmission periods, keeps the even wires (e.g., the wires 220 and 222) static and sends the odd bit values (e.g., underlined ones of 1101) via the odd wires (e.g., the wires 221 and 223) during a time period 260 (e.g. 2) corresponding to a third transmission period that is next after the second transmission period. The transmitter 142 also stores the first set of bit values (e.g., 1101) for a fourth transmission period that is next after the third transmission period. The transmitter 142 thus sends a first set of encoded bit values (e.g., 1111) using the first subset of wires (e.g., the wires 220-223) during the time period 260 (e.g., 2) corresponding to the third transmission period. Since the first set of encoded bit values (e.g., 1111) includes static even bit values, there are no adjacent wires that transition in opposite directions and a transition pattern (e.g., - - - -) of the first set of encoded bit values does not match a cross-talk pattern.

In a particular embodiment, the transmitter 142, in response to determining that the second set of bit values (e.g., 0101) are to be transmitted during a single transmission period, as described with reference to FIG. 8A, sends the second set of bit values (e.g., 0101) using the second subset of wires (e.g., the wires 224-227) during the time period 260 (e.g., 2) corresponding to the third transmission period. Encoded data 264 sent during the third transmission period thus includes the first set of encoded bit values (e.g., 1111) and the second set of bit values (e.g., 0101).

Referring to FIG. 8C, a diagram 890 is shown of an illustrative aspect of operations at the link decoder 134 associated with the encoding talk pattern detection example, in accordance with some examples of the present disclosure.

The receiver 144 receives the encoded data 264 (e.g., 1111 0101) via the communication link 150 during the time period 260 (e.g., 2) corresponding to the third transmission period. The link decoder 134 determines transition patterns of the sets of bit values received via the subsets of wires. For example, the link decoder 134 determines a first detected transition pattern (e.g., - - - -) of the first set of bit values (e.g., 1111) and a second detected transition pattern (e.g., v - v -) of the second set of bit values (e.g., 0101).

The link decoder 134, based on determining that the first detected transition pattern (e.g., - - - -) matches a first transition pattern (e.g., static even bit values) corresponding to a first stage of an encoding pattern, determines that the first transition pattern (e.g., static even bit values) is detected. The link decoder 134, based on determining that the first transition pattern (e.g., static even bit values) is detected, holds the first set of bit values (e.g., 1111) as tentatively decoded data 266 that is potentially encoded with next bit values to be received via the first subset of wires (e.g., the wires 220-223).

The link decoder 134, based on determining that the second detected transition pattern (e.g., v - v -) does not match the first transition pattern (e.g., static even bit values), determines that the second set of bit values (e.g., 0101) are not potentially encoded. However, the link decoder 134 holds the second set of bit values (e.g., 0101) because the first set of bit values (e.g., 1111) that are prior to the second set of bit values are being held as potentially encoded.

The link decoder 134, based on determining that the first set of bit values (e.g., 1111) are being held as potentially encoded, outputs the previously held first set of bit values (e.g., 1111) as output data 268. The link decoder 134, based on determining the first set of bit values (e.g., 1111) that were previously being held as potentially encoded are no longer being held and that the second set of bit values (e.g., 1111) were previously being held because the first set of bit values (e.g., 1111) were being held, outputs the second set of bit values (e.g., 1111) as output data 268. The output data 268 thus includes the first set of bit values (e.g., 1111) and the second set of bit values (e.g., 1111) that were received during the time period 260 (e.g., 1) corresponding to the second transmission period.

Referring to FIG. 9A, a diagram 900 is shown of an illustrative aspect of operations at the link encoder 132 associated with the encoding pattern detection example, in accordance with some examples of the present disclosure.

The transmitter 142, in response to determining that stored first set of bit values (e.g., 1101) are to be sent during two transmission periods, as described with reference to FIG. 8A and that the next transmission period corresponds to a second one of the two transmission periods, keeps the odd wires (e.g., the wires 221 and 223) static and sends even bit values (e.g., underlined ones of 1101) via the even wires (e.g., the wires 220 and 222) during a time period 260 (e.g., 3) corresponding to the fourth transmission period.

The link encoder 132, instead of obtaining two sets of bit values from the input data stream 252 to send during the next transmission period, shifts the input data stream 252 by one set and obtains a single set of bit values (e.g., 1111) as a second set of bit values to be transmitted via the second subset of wires (e.g., the wires 224-227).

The link encoder 132 determines a second detected transition pattern (e.g., \hat{ } - \hat{ } v) of the second set of bit values (e.g., 1111) based on a comparison of the second set of bit values to be sent and a second set of bit values (e.g., 0101) previously sent via the second subset of wires (e.g., the wires 224-227). The link encoder 132, based on determining that the second detected transition pattern does not match a cross-talk pattern and that the second detected transition pattern does not match a first transition pattern (e.g., static even bits) corresponding to a first stage of an encoding pattern, determines that the second set of bit values (e.g., 1111) are to be sent using the second subset of wires (e.g., the wires 224-227) during a single transmission period (e.g., the fourth transmission period). Encoded data 264 sent during the fourth transmission period thus includes the first set of bit values (e.g., 1101) and the second set of bit values (e.g., 1111).

Referring to FIG. 9B, a diagram of an illustrative aspect of operations at the decoder associated with the encoding pattern detection example, in accordance with some examples of the present disclosure is shown.

The receiver 144 receives the encoded data 264 (e.g., 1101 1111) via the communication link 150 during the time period 260 (e.g., 3) corresponding to the fourth transmission period. For example, the receiver 144 receives a first set of bit values (e.g., 1101) via the first subset of wires (e.g., the wires 220-223) and receives a second set of bit values (e.g., 1100) via the second subset of wires (e.g., the wires 224-227).

The link decoder 134 determines transition patterns of the sets of bit values received via the subsets of wires. For example, the link decoder 134 determines a first detected transition pattern (e.g., - - v -) of the first set of bit values (e.g., 1101) based on a comparison of the first set of bit values (e.g., 1101) received during the fourth transmission period and a first set of bit values (e.g., 1111) received during the third transmission period via the first subset of wires (e.g., the wires 220-223). As another example, the link decoder 134 determines a second detected transition pattern (e.g., \hat{ } - \hat{ } -) of the second set of bit values (e.g., 1111) based on a comparison of the second set of bit values (e.g., 1111) received during the fourth transmission period and a second set of bit values (e.g., 0101) received during the third transmission period via the second subset of wires (e.g., the wires 224-227).

The link decoder 134 determines that the first detected transition pattern (e.g., - - v -) matches a second transition pattern (e.g., static odd bit values) corresponding to a second stage of an encoding pattern and determines that the second transition pattern (e.g., static odd bit values) is detected. The link decoder 134, based on determining that the second transition pattern (e.g., static odd bit values) is detected during the fourth transmission period subsequent to the first transition pattern (e.g., static even bit values) during the third transmission period, as described with reference to FIG. 8C, determines that an encoding pattern is detected. The link decoder 134, in response to determining that an encoding pattern is detected, discards the first set of bit values (e.g., 1111) that were held over from the third transmission period, and outputs the first set of bit values (e.g., 1101) received during the third transmission period as decoded data 266 in the output data stream 254. The link decoder 134, in response to determining that the first set of bit values (e.g., 1101) have replaced the first set of bit values (e.g., 1111) that were held over, outputs the second set of bit values (e.g., 0101) from the decoded data 266 that was held over from the third transmission period in the output data stream 254.

The link decoder 134, in response to determining that there is no data held over and that the second detected transition pattern (e.g., \hat{ } - \hat{ } -) does not match the first transition pattern (e.g., static even bits) corresponding to the first stage of an encoding pattern, outputs the second set of bit values (e.g., 1111) as decoded data 266 in the output data stream 254 during the fourth transmission period. Output data 268 of the fourth transmission period thus includes the first set of bit values (e.g., 1101) received during the fourth transmission period, the second set of bit values (e.g., 0101) received during the third transmission period, and the second set of bit values (e.g., 1111) received during the fourth transmission period.

Sending the first set of bit values (e.g., 1101) during two transmission periods (e.g., the third transmission period and the fourth transmission period) solves the problem of the link decoder 134 incorrectly discarding a set of bit values that matches an encoding pattern.

Referring to FIG. 10, a diagram 1000 is shown of an illustrative aspect of operations at a link encoder 132 and a link decoder 134 associated with a flag wire example, in accordance with some examples of the present disclosure.

The communication link 150 includes flag wires associated with respective subsets of wires. For example, the communication link 150 includes a flag wire 1020 associated with a first subset of wires (e.g., the wires 220-223). As another example, the communication link 150 includes a flag wire 1022 associated with a second subset of wires (e.g., the wires 224-227). In a particular embodiment, the communication link 150 includes a shield (not shown) between a flag wire and the respective subset of wires. For example, in a particular embodiment, the communication link 150 includes a shield between the flag wire 1020 and the wire 220.

A flag wire is configured to indicate whether a corresponding subset of wires is being used to send a set of bit values during a single transmission period or during two transmission periods. For example, a flag wire bit value 1040 of the flag wire 1020 corresponding to a first value (e.g., 0) indicates that the first subset of wires (e.g., the wires 220-223) is being used to transmit a set of bit values during a single transmission period. The flag wire bit value 1040 of the flag wire 1020 corresponding to a second value (e.g., 1) indicates that the first subset of wires (e.g., the wires 220-223) is being used to transmit a set of bit values during two transmission periods. Similarly, a flag wire bit value 1042 of the flag wire 1022 indicates whether the second subset of wires (e.g., the wires 224-227) is being used to send a set of bit values during a single transmission period or two transmission periods.

During operation, the link encoder 132 obtains an input data stream 252 for transmission via the communication link 150, as described with reference to FIG. 2. The link encoder 132 determines that a first set of bit values (e.g., 1010) and a second set of bit values (e.g., 0101) of the input data stream 252 are to be sent via the first subset of wires and the second subset of wires, respectively, during a time period 260 (e.g., 0) corresponding to a first transmission period.

The transmitter 142 transmits the first set of bit values (e.g., 1010) via the first subset of wires (e.g., the wires 220-223) and the second set of bit values (e.g., 0101) via the second subset of wires (e.g., the wires 224-227) as encoded data 264 during the time period 260 (e.g., 0) corresponding to the first transmission period. The transmitter 142 also transmits a first bit value (e.g., 0) via the flag wire 1020 concurrently with transmitting the first set of bit values (e.g., 1010) via the first subset of wires (e.g., the wires 220-223), and transmits the first bit value (e.g., 0) via the flag wire 1022 concurrently with transmitting the second set of bit values (e.g., 0101) via the second subset of wires (e.g., the wires 224-227).

The receiver 144 receives the first set of bit values (e.g., 1010) via the first subset of wires (e.g., the wires 220-223) and the second set of bit values (e.g., 0101) via the second subset of wires (e.g., the wires 224-227) as the encoded data 264 during the time period 260 (e.g., 0) corresponding to the first transmission period. The receiver 144 also receives the flag wire bit value 1040 (e.g., 0) via the flag wire 1020 and the flag wire bit value 1042 (e.g., 0) via the flag wire 1022 during the time period 260 (e.g., 0) corresponding to the first transmission period.

The link decoder 134, based on determining that each of the flag wire bit value 1040 (e.g., 0) and the flag wire bit value 1042 (e.g., 0) indicates that a single transmission period is being used, determines that decoded data 266 includes the first set of bit values (e.g., 1010) and the second set of bit values (e.g., 0101) and outputs the decoded data 266 as output data 268 (e.g., 1010 0101) of an output data stream 254.

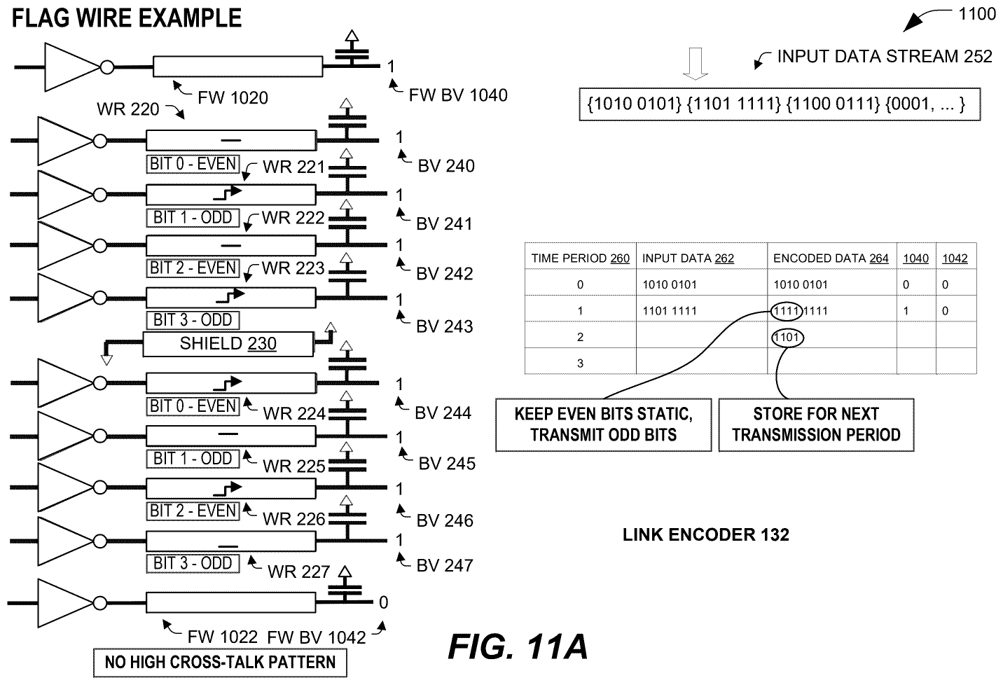

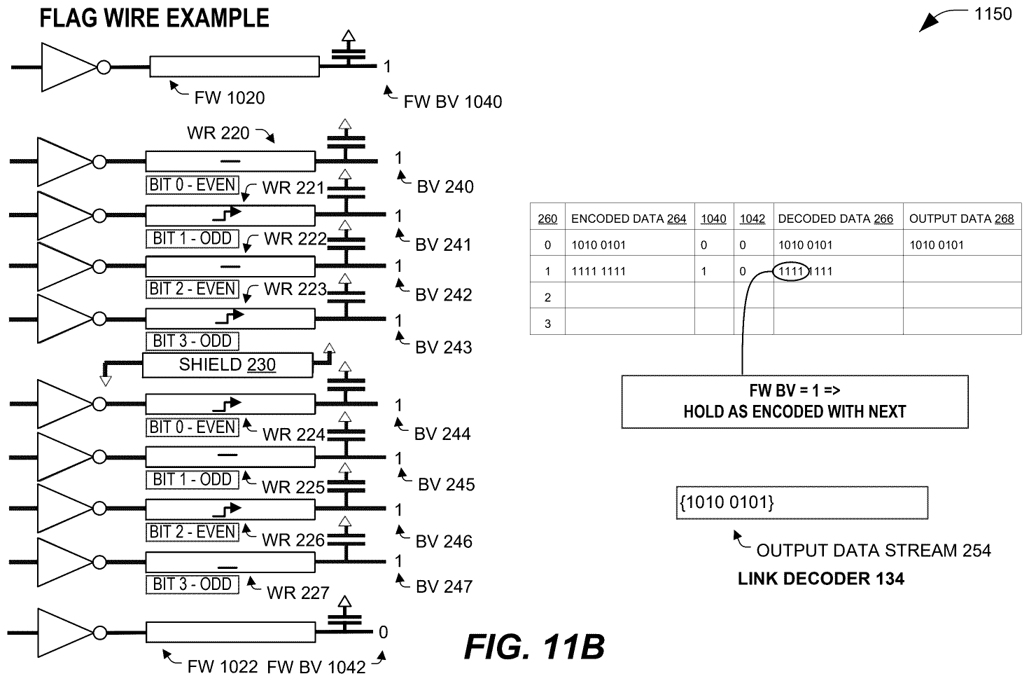

Referring to FIG. 11A, a diagram 1100 is shown of an illustrative aspect of operations at the link encoder 132 associated with the flag wire example, in accordance with some examples of the present disclosure.

The link encoder 132 determines that a first set of bit values (e.g., 1101) and a second set of bit values (e.g., 1111) of the input data stream 252 are to be sent via the first subset of wires and the second subset of wires, respectively, during a time period 260 (e.g., 1) corresponding to a second transmission period that is subsequent to the first transmission period.

The link encoder 132 determines transition patterns associated with sets of bit values to be sent via subsets of wires of the communication link 150, as described with reference to FIG. 3A. For example, the link encoder 132 determines a first transition pattern (e.g., - \hat{ } V \hat{ }) associated with the first set of bit values (e.g., 1101) and a second transition pattern (e.g., \hat{ } - \hat{ } -) associated with the second set of bit values (e.g., 1111).

The link encoder 132 determines whether any of the transition patterns match a cross-talk pattern, as described with reference to FIG. 3A. For example, the link encoder 132 determines that the first transition pattern (e.g., - \hat{ } v \hat{ }) matches a cross-talk pattern and that the second transition pattern (e.g., \hat{ } - \hat{ } -) does not match a cross-talk pattern.

The link encoder 132, based on determining that the first transition pattern matches a cross-talk pattern, determines that the first set of bit values (e.g., 1101) are to be sent during two transmission periods. The link encoder 132, based on determining that the second transition pattern does not match a cross-talk pattern, determines that the second set of bit values (e.g., 1111) are to be sent during one transmission period.

The transmitter 142, in response to determining that the first set of bit values (e.g., 1101) are to be sent during two transmission periods, keeps the even wires (e.g., the wires 220 and 222) static and sends the odd bit values (e.g., underlined ones of 1101) via the odd wires (e.g., the wires 221 and 223) during a time period 260 (e.g. 1) corresponding to a second transmission period that is next after the first transmission period. The transmitter 142 also sends a second value (e.g., 1) via the flag wire 1020 concurrently with sending a first set of encoded bit values (e.g., 1111) via the first subset of wires (e.g., the wires 220-223). The transmitter 142 stores the first set of bit values (e.g., 1101) for a third transmission period that is next after the second transmission period.

In a particular embodiment, the transmitter 142, in response to determining that the second set of bit values (e.g., 1111) are to be transmitted during a single transmission period, sends the second set of bit values (e.g., 1111) using the second subset of wires (e.g., the wires 224-227) during the time period 260 (e.g., 1) corresponding to the second transmission period. The transmitter 142 also sends a first value (e.g., 0) via the flag wire 1022 concurrently with sending the second set of bit values (e.g., 1111) via the second subset of wires (e.g., the wires 224-227).

Encoded data 264 sent during the second transmission period thus includes the first set of encoded bit values (e.g., 1111) and the second set of bit values (e.g., 1111). The flag wire bit value 1040 (e.g., 1) indicates that the first subset of wires (e.g., the wires 220-223) are being used to send a set of bit values during two transmission periods. The flag wire bit value 1042 (e.g., 0) indicates that the second subset of wires (e.g., the wires 224-227) are being used to send a set of bit values during a single transmission period.

Referring to FIG. 11B, a diagram 1150 is shown of an illustrative aspect of operations at the link decoder 134 associated with the flag wire example, in accordance with some examples of the present disclosure.

The receiver 144 receives the encoded data 264 (e.g., 1111 1111) via the communication link 150 during the time period 260 (e.g., 1) corresponding to the second transmission period. For example, the receiver 144 receives a first set of bit values (e.g., 1111) via the first subset of wires (e.g., the wires 220-223) and receives a second set of bit values (e.g., 1111) via the second subset of wires (e.g., the wires 224-227).

The receiver 144 receives flag wire bit values concurrently with receiving the encoded data 264. For example, the receiver 144 receives the flag wire bit value 1040 via the flag wire 1020 concurrently with receiving the first set of bit values (e.g., 1111) via the first subset of wires (e.g., the wires 220-223). As another example, the receiver 144 receives the flag wire bit value 1042 via the flag wire 1022 concurrently with receiving the second set of bit values (e.g., 1111) via the second subset of wires (e.g., the wires 224-227).

The link decoder 134, based on determining that the flag wire bit value 1040 (e.g., 1) indicates that multiple transmission periods are being used, holds the first set of bit values (e.g., 1111) as encoded with next bit values to be received via the first subset of wires (e.g., the wires 220-223). The link decoder 134, based on determining that the flag wire bit value 1042 (e.g., 0) indicates that a single transmission period is used, determines that the second set of bit values (e.g., 1111) are not encoded. However, the link decoder 134 holds the second set of bit values (e.g., 1111) because the first set of bit values (e.g., 1111), that are prior to the second set of bit values, are encoded with the next bit values.

In a particular embodiment, the link decoder 134, based on determining that the flag wire bit value 1040 indicated a first value (e.g., 0) during the first transmission period and that the flag wire bit value 1040 indicates a second value (e.g., 1) during the second transmission period, discards the first set of bit values (e.g., 1111) and holds the second set of bit values (e.g., 1111). The link decoder 134 refrains from outputting the decoded data 266 as output data 268 during the time period 260 (e.g., 1) corresponding to the second transmission period.

Referring to FIG. 12A, a diagram 1200 is shown of an illustrative aspect of operations at the link encoder 132 associated with the flag wire example, in accordance with some examples of the present disclosure.

The transmitter 142, in response to determining that stored first set of bit values (e.g., 1101) are to be sent during two transmission periods, as described with reference to FIG. 11A and that the next transmission period corresponds to a second one of the two transmission periods, keeps the odd wires (e.g., the wires 221 and 223) static and sends even bit values (e.g., underlined ones of 1101) via the even wires (e.g., the wires 220 and 222) during a time period 260 (e.g., 2) corresponding to the third transmission period, as described with reference to FIG. 4A. The transmitter 142 also transmits a second value (e.g., 1) via the flag wire 1020 concurrently with transmitting the first set of bit values (e.g., 1101) via the first subset of wires (e.g., the wires 220-223) during the third transmission period.

The link encoder 132, instead of obtaining two sets of bit values from the input data stream 252 to send during the next transmission period, shifts the input data stream 252 by one set and obtains a single set of bit values (e.g., 1100) as a second set of bit values to be transmitted via the second subset of wires (e.g., the wires 224-227).

The link encoder 132 determines a second transition pattern (e.g., - - v v) of the second set of bit values (e.g., 1100), as described with reference to FIG. 4A. The link encoder 132, based on determining that the second transition pattern does not match a cross-talk pattern, determines that the second set of bit values (e.g., 1100) are to be sent using the second subset of wires (e.g., the wires 224-227) during a single transmission period (e.g., the third transmission period). The transmitter 142, in response to determining that the second set of bit values (e.g., 1100) are to be sent during a single transmission period, sends the second set of bit values (e.g., 1100) via the second subset of wires (e.g., the wires 224-227), as described with reference to FIG. 4A. The transmitter 142 also transmits a first value (e.g., 0) via the flag wire 1022 concurrently with transmitting the second set of bit values (e.g., 1100) via the second subset of wires (e.g., the wires 224-227) during the third transmission period.

Encoded data 264 sent during the third transmission period thus includes the first set of bit values (e.g., 1101) and the second set of bit values (e.g., 1100). The flag wire bit value 1040 (e.g., 1) indicates that the first subset of wires (e.g., the wires 220-223) are being used to send a set of bit values during multiple transmission periods. The flag wire bit value 1042 (e.g., 0) indicates that the second subset of wires (e.g., the wires 224-227) are being used to send a set of bit values during a single transmission period.

Referring to FIG. 12B, a diagram 1250 is shown of an illustrative aspect of operations at the link decoder 134 associated with the flag wire example, in accordance with some examples of the present disclosure.

The receiver 144 receives the encoded data 264 (e.g., 1101 1100) via the communication link 150 during the time period 260 (e.g., 2) corresponding to the third transmission period. For example, the receiver 144 receives a first set of bit values (e.g., 1101) via the first subset of wires (e.g., the wires 220-223) and receives a second set of bit values (e.g., 1100) via the second subset of wires (e.g., the wires 224-227).

The receiver 144 receives flag wire bit values concurrently with receiving the encoded data 264. For example, the receiver 144 receives the flag wire bit value 1040 (e.g., 1) via the flag wire 1020 concurrently with receiving the first set of bit values (e.g., 1101) via the first subset of wires (e.g., the wires 220-223). As another example, the receiver 144 receives the flag wire bit value 1042 (e.g., 0) via the flag wire 1022 concurrently with receiving the second set of bit values (e.g., 1100) via the second subset of wires (e.g., the wires 224-227).

The link decoder 134, based on determining that the flag wire bit value 1040 (e.g., 1) received during the third transmission period indicates that multiple transmission periods are being used and that a flag wire bit value 1040 (e.g., 1) received during the second transmission period indicated that multiple transmission periods are being used, discards any previously stored first set of bit values (e.g., 1111) and outputs the first set of bit values (e.g., 1101) received during the third transmission period as decoded data 266 in the output data stream 254. In a particular aspect, the link decoder 134, based on determining that the flag wire bit value 1040 (e.g., 1) received during the second transmission period indicated that multiple transmission periods are being used, determines that a first transition pattern (e.g., static even bits) of an encoding pattern is detected. In this aspect, the link decoder 134, based on determining that the flag wire bit value 1040 (e.g., 1) received during the third transmission period indicates that multiple transmission periods are being used and that the flag wire bit value 1040 (e.g., 1) received during the second transmission period indicated that multiple transmission periods are being used, determines that a second transition pattern (e.g., static odd bits) of the encoding pattern is detected and that the encoding pattern is detected. The link decoder 134, based on determining that the encoding pattern is detected, discards any previously stored first set of bit values (e.g., 1111) and outputs the first set of bit values (e.g., 1101) received during the third transmission period as decoded data 266 in the output data stream 254.

The link decoder 134, in response to determining that the first set of bit values (e.g., 1101) have replaced the first set of bit values (e.g., 1111) that were received during the second transmission period, outputs the second set of bit values (e.g., 1111) from the decoded data 266 that was held over from the second transmission period in the output data stream 254.

The link decoder 134, in response to determining that there is no data held over and that the flag wire bit value 1042 (e.g., 0) indicates that a single transmission period is being used, outputs the second set of bit values (e.g., 1100) as decoded data 266 in the output data stream 254 during the third transmission period. Output data 268 of the third transmission period thus includes the first set of bit values (e.g., 1101) received during the third transmission period, the second set of bit values (e.g., 1111) received during the second transmission period, and the second set of bit values (e.g., 1100) received during the third transmission period.

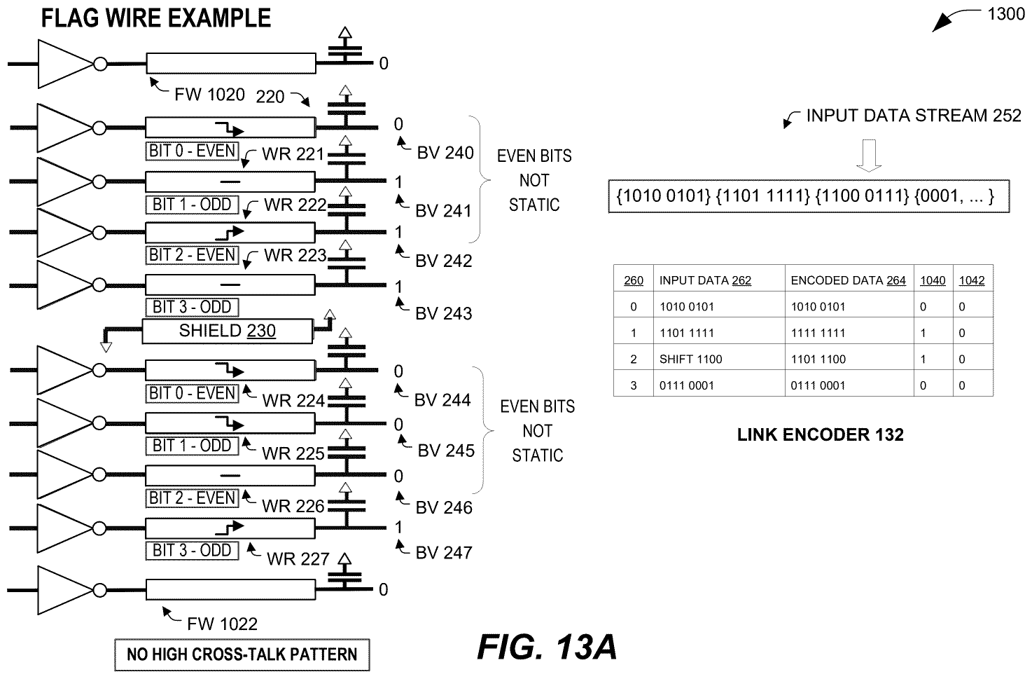

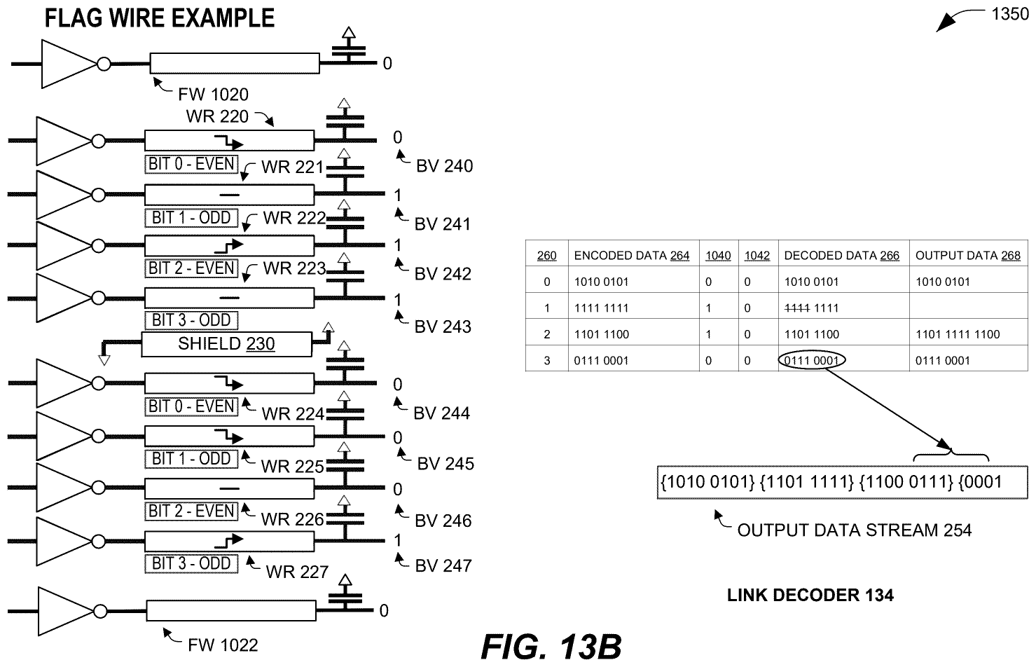

Referring to FIG. 13A, a diagram 1300 is shown of an illustrative aspect of operations at the link encoder 132 associated with the flag wire example, in accordance with some examples of the present disclosure.

The link encoder 132 determines that a first set of bit values (e.g., 0111) and a second set of bit values (e.g., 0001) of the input data stream 252 are to be sent via the first subset of wires and the second subset of wires, respectively, during a time period 260 (e.g., 3) corresponding to a fourth transmission period that is subsequent to the third transmission period.

The link encoder 132 determines transition patterns associated with sets of bit values to be sent via subsets of wires of the communication link 150, as described with reference to FIG. 5A. For example, the link encoder 132 determines a first transition pattern (e.g., v - \hat{ } -) associated with the first set of bit values (e.g., 0111) and a second transition pattern (e.g., v v - \hat{ }) associated with the second set of bit values (e.g., 0001) to be sent and the second set of bit values (e.g., 1100) previously sent via the second subset of wires (e.g., the wires 224-227).

The link encoder 132 determines whether any of the transition patterns match a cross-talk pattern. For example, the link encoder 132 determines that neither the first transition pattern (e.g., v - \hat{ } -) nor the second transition pattern (e.g., v v - \hat{ }) matches a cross-talk pattern and hence each of the first set of bit values (e.g., 0111) and the second set of bit values (e.g., 0001) are to be sent during a single transmission period.

The transmitter 142 sends the sets of bit values based on the determination. For example, the transmitter 142 sends the first set of bit values (e.g., 0111) using the first subset of wires (e.g., the wires 220-223) and sends the second set of bit values (e.g., 0001) using the second subset of wires (e.g., the wires 224-227) during the time period 260 (e.g., 3) corresponding to the fourth transmission period. The transmitter 142 also transmits a first value (e.g., 0) via the flag wire 1020 concurrently with transmitting the first set of bit values (e.g., 0111) via the first subset of wires (e.g., the wires 220-223) during the fourth transmission period. The transmitter 142 transmits the first value (e.g., 0) via the flag wire 1022 concurrently with transmitting the second set of bit values (e.g., 0001) via the second subset of wires (e.g., the wires 224-227) during the fourth transmission period.

Encoded data 264 sent during the fourth transmission period thus includes the first set of bit values (e.g., 0111) and the second set of bit values (e.g., 0001). The flag wire bit value 1040 (e.g., 0) indicates that the first subset of wires (e.g., the wires 220-223) are being used to send a set of bit values during a single transmission period. The flag wire bit value 1042 (e.g., 0) indicates that the second subset of wires (e.g., the wires 224-227) are being used to send a set of bit values during a single transmission period.

Referring to FIG. 13B, a diagram 1350 is shown of an illustrative aspect of operations at the link decoder 134 associated with the flag wire example, in accordance with some examples of the present disclosure.

The receiver 144 receives the encoded data 264 (e.g., 0111 0001) via the communication link 150 during the time period 260 (e.g., 3) corresponding to the fourth transmission period. For example, the receiver 144 receives a first set of bit values (e.g., 0111) via the first subset of wires (e.g., the wires 220-223) and receives a second set of bit values (e.g., 0001) via the second subset of wires (e.g., the wires 224-227).

The receiver 144 receives flag wire bit values concurrently with receiving the encoded data 264. For example, the receiver 144 receives the flag wire bit value 1040 (e.g., 0) via the flag wire 1020 concurrently with receiving the first set of bit values (e.g., 0111) via the first subset of wires (e.g., the wires 220-223). As another example, the receiver 144 receives the flag wire bit value 1042 (e.g., 0) via the flag wire 1022 concurrently with receiving the second set of bit values (e.g., 0001) via the second subset of wires (e.g., the wires 224-227).

The link decoder 134, based on determining that each of the flag wire bit value 1040 (e.g., 0) and the flag wire bit value 1042 indicates that a single transmission period is being used, outputs the first set of bit values (e.g., 0111) and the second set of bit values (e.g., 0001) as decoded data 266 in the output data stream 254 during the fourth transmission period. Output data 268 of the fourth transmission period thus includes the first set of bit values (e.g., 0111) and the second set of bit values (e.g., 0001) received during the fourth transmission period.

Using the flag wires simplifies the determination at the link decoder 134 regarding whether multiple transmission periods are being used without having to detect an encoding pattern based on comparisons of sets of bit values and solves the problem of the link decoder 134 incorrectly discarding a set of bit values that matches an encoding pattern.

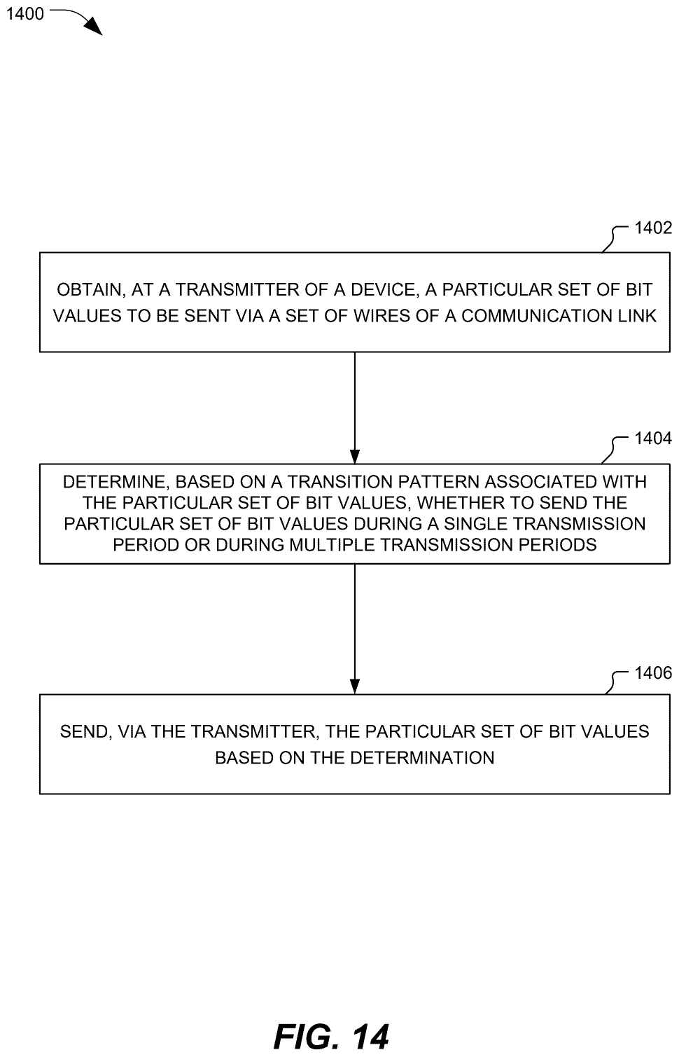

Referring to FIG. 14, a particular implementation of a method 1400 of transmitting data using a communication link is shown. In a particular aspect, one or more operations of the method 1400 are performed at least by one of a transmitter 142, a link encoder 132, the device 102, the system 100 of FIG. 1, or a combination thereof.

The method 1400 includes obtaining, at a transmitter of a device, a particular set of bit values to be sent via a set of wires of a communication link, at block 1402. For example, a link encoder 132 of a transmitter 142 of the device 102 obtains a particular set of bit values to be sent via a set of wires of the communication link 150, as described with reference to FIGS. 1 and 2.

The method 1400 also includes determining, based on a transition pattern associated with the particular set of bit values, whether to send the particular set of bit values during a single transmission period or during multiple transmission periods, at block 1404. For example, the link encoder 132 determines, based on a transition pattern associated with the particular set of bit values, whether to send the particular set of bit values during a single transmission period or during multiple transmission periods, as described with reference to FIGS. 1, 3A, 5A, 7A, 8A, 11A, and 13A. In a particular embodiment, the link encoder 132, based on detecting a cross-talk pattern or an encoding pattern, determines that the particular set of bits values are to be sent during multiple transmission periods. Alternatively, the link encoder 132, in response to determining that neither a cross-talk pattern nor an encoding pattern is detected, determines that the particular set of bit values are to be sent during a single transmission period. In another embodiment, the link encoder 132 determines whether to use a single transmission period or multiple transmission periods based on whether a cross-talk pattern is detected and independently of detecting an encoding pattern, as described with reference to the flag wire example of FIGS. 10-13B.

The method 1400 further includes sending, via the transmitter, the particular set of bit values based on the determination, at block 1406. For example, the transmitter 142 sends the particular set of bit values based on the determination, as described with reference to FIGS. 1, 3A, 5A, 7A, 8A, 11A, and 13A.

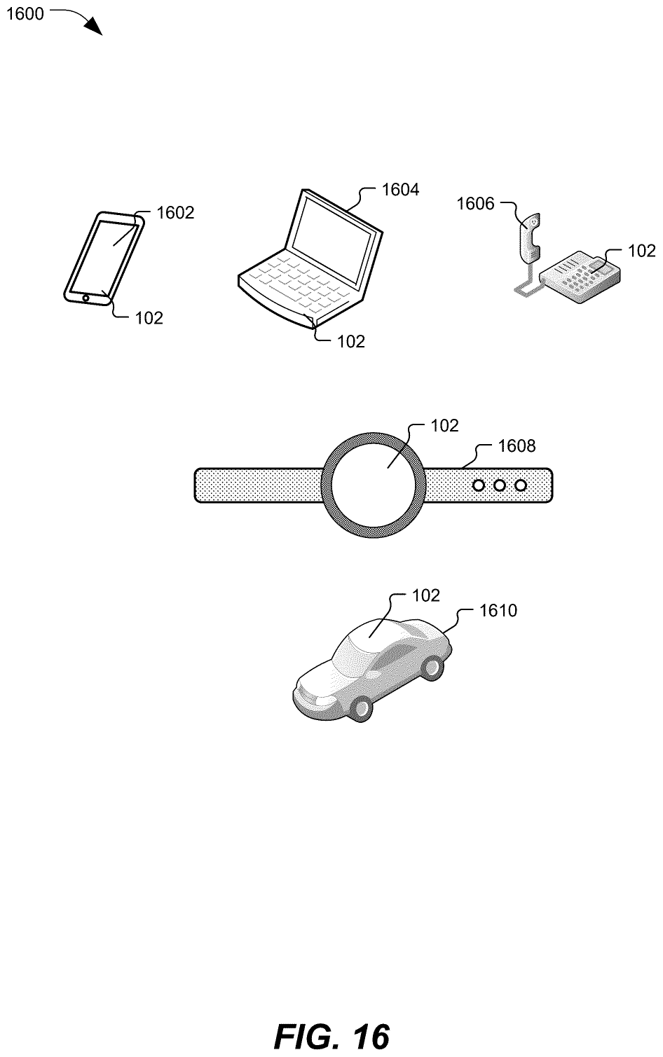

It should be noted that while FIG. 14 shows example blocks of method 1400, in some implementations, the method 1400 may include additional blocks, fewer blocks, different blocks, or differently arranged blocks than those depicted in FIG. 14. The method 1400 of FIG. 14 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 1400 of FIG. 14 may be performed by a processor that executes instructions, such as described with reference to FIG. 16.

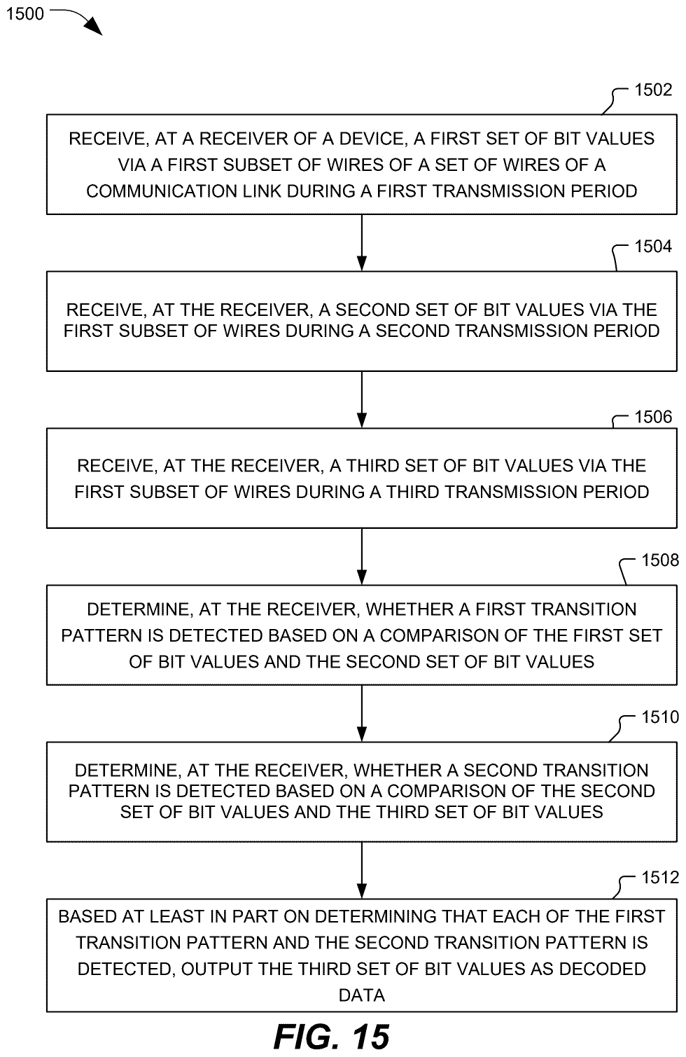

Referring to FIG. 15, a particular implementation of a method 1500 of receiving data using a communication link is shown. In a particular aspect, one or more operations of the method 1500 are performed by at least one of a receiver 144, a link decoder 134, the device 102, the system 100 of FIG. 1, or a combination thereof.

The method 1500 includes receiving, at a receiver of a device, a first set of bit values via a first subset of wires of the set of wires of a communication link during a first transmission period, at block 1502. For example, a link decoder 134 of a receiver 144 of the device 102 receives a first set of bit values (e.g., the bit values 240-243) via a first subset of wires (e.g., the wires 220-223) of the communication link 150 during a first transmission period, as described with reference to FIGS. 1 and 2.

The method 1500 also includes receiving, at the receiver, a second set of bit values via the first subset of wires during a second transmission period, at block 1504. For example, the link decoder 134 receives a second set of bit values (e.g., bit values 240-243) via the first subset of wires during a second transmission period, as described with reference to FIGS. 3C, 4B, 5B, 7B, 8C, 9B, 11B, 12B, and 13B.

The method 1500 further includes receiving, at the receiver, a third set of bit values via the first subset of wires during a third transmission period, at block 1506. For example, the link decoder 134 receives a third set of bit values (e.g., bit values 240-243) via the first subset of wires during a third transmission period, as described with reference to FIGS. 4B, 5B, 8C, 9B, 12B, and 13B.

The method 1500 also includes determining, at the receiver, whether a first transition pattern is detected based on a comparison of the first set of bit values and the second set of bit values, at block 1508. For example, the link decoder 134 determines whether a first transition pattern (e.g., static even bits) is detected based on a comparison of the first set of bit values and the second set of bit values, as described with reference to FIGS. 3C, 4B, 5B, 7B, 8C, 9B, 11B, 12B, and 13B.

The method 1500 further includes determining, at the receiver, whether a second transition pattern is detected based on a comparison of the second set of bit values and the third set of bit values, at block 1510. For example, the link decoder 134 determines whether a second transition pattern (e.g., odd even bits) is detected based on a comparison of the second set of bit values and the third set of bit values, as described with reference to FIGS. 4B, 5B, 8C, 9B, 12B, and 13B.

The method 1500 also includes, based at least in part on determining that each of the first transition pattern and the second transition pattern is detected, outputting the third set of bit values as decoded data, at block 1512. For example, the link decoder 134, based on determining that each of the first transition pattern and the second transition pattern is detected, outputs the third set of bit values as decoded data, as described with reference to FIGS. 4B, 9B, and 12B. Similarly, in another example, the link decoder 134, based on determining that each of a first transition pattern, a second transition pattern, and a third transition pattern is detected, determines that an encoding pattern associated with three transmission periods is detected and outputs a fourth set of bit values as decoded data, as described with reference to FIG. 1.

It should be noted that while FIG. 15 shows example blocks of method 1500, in some implementations, the method 1500 may include additional blocks, fewer blocks, different blocks, or differently arranged blocks than those depicted in FIG. 15. The method 1500 of FIG. 15 may be implemented by a FPGA device, an ASIC, a processing unit such as a CPU, a DSP, a controller, another hardware device, firmware device, or any combination thereof. As an example, the method 1500 of FIG. 15 may be performed by a processor that executes instructions, such as described with reference to FIG. 16.

FIG. 16 illustrates various electronic devices that may include or correspond to the device 102. For example, a mobile phone device 1602, a laptop computer device 1604, a fixed location terminal device 1606, a wearable device 1608, or a vehicle 1610 (e.g., an automobile or an aerial device) may include the device 102. The devices 1602, 1604, 1606 and 1608 and the vehicle 1610 illustrated in FIG. 16 are merely exemplary. Other electronic devices may also feature the device 102 including, but not limited to, a group of devices (e.g., electronic devices) that includes mobile devices, hand-held personal communication systems (PCS) units, portable data units such as personal digital assistants, global positioning system (GPS) enabled devices, navigation devices, set top boxes, music players, video players, entertainment units, fixed location data units such as meter reading equipment, communications devices, smartphones, tablet computers, computers, wearable devices (e.g., watches, glasses), Internet of things (IoT) devices, servers, routers, electronic devices implemented in vehicles (e.g., autonomous vehicles), or any other device that stores or retrieves data or computer instructions, or any combination thereof.

In a particular implementation, the device 102 includes at least one processor and a memory that stores instructions that are executable by the at least one processor to implement functionality described with reference to a link encoder 132, a link decoder 134, a transmitter 142, a receiver 144, or a combination thereof. In some implementations, a non-transitory computer-readable medium (e.g., a computer-readable storage device, such as a memory) includes instructions that, when executed by at least one processor, cause the at least one processor to obtain, at a transmitter (e.g., a transmitter 142) of a device (e.g., the device 102), a particular set of bit values (e.g., the bit values 240-243) to be sent via a set of wires (e.g., the wires 220-223) of a communication link (e.g., the communication link 150). The instructions, when executed by the at least one processor, also cause the at least one processor to determine, based on a transition pattern associated with the particular set of bit values, whether to send the particular set of bit values during a single transmission period or during multiple transmission periods. The instructions, when executed by the at least one processor, further cause the at least one processor to send, via the transmitter, the particular set of bit values based on the determination.

In some implementations, a non-transitory computer-readable medium (e.g., a computer-readable storage device, such as a memory) includes instructions that, when executed by at least one processor, cause the at least one processor to receive, at a receiver (e.g., a receiver 144) of a device (e.g., the device 102), a first set of bit values (e.g., the bit values 240-243) via a first subset of wires (e.g., the wires 220-223) of a set of wires (e.g., the wires 220-223) of a communication link (e.g., the communication link 150) during a first transmission period. The instructions, when executed by the at least one processor, also cause the at least one processor to receive, at the receiver, a second set of bit values (e.g., the bit values 240-243) via the first subset of wires during a second transmission period. The instructions, when executed by the at least one processor, further cause the at least one processor to receive, at the receiver, a third set of bit values (e.g., the bit values 240-243) via the first subset of wires during a third transmission period. The instructions, when executed by the at least one processor, also cause the at least one processor to determine, at the receiver, whether a first transition pattern is detected based on a comparison of the first set of bit values and the second set of bit values. The instructions, when executed by the at least one processor, further cause the at least one processor to determine, at the receiver, whether a second transition pattern is detected based on a comparison of the second set of bit values and the third set of bit values. The instructions, when executed by the at least one processor, also cause the at least one processor to, based at least in part on determining that each of the first transition pattern and the second transition pattern is detected, output the third set of bit values as decoded data.

In conjunction with the described implementations, an apparatus includes means for obtaining, at a transmitter of a device, a particular set of bit values to be sent via a set of wires of a communication link. For example, the means for obtaining can correspond to a link encoder 132, a transmitter 142, the device 102, the system 100 of FIG. 1, a processor, one or more other circuits or components configured to obtain a particular set of bit values to be sent via a set of wires of a communication link, or any combination thereof.

The apparatus also includes means for determining, based on a transition pattern associated with the particular set of bit values, whether to send the particular set of bit values during a single transmission period or during multiple transmission periods. For example, the means for determining can correspond to a link encoder 132, a transmitter 142, the device 102, the system 100 of FIG. 1, a processor, one or more other circuits or components configured to determine whether to send the particular bit values during a single transmission period or during multiple transmission periods, or any combination thereof.

The apparatus further includes means for sending, via the transmitter, the particular set of bit values based on the determination. For example, the means for sending can correspond to a link encoder 132, a transmitter 142, the device 102, the system 100 of FIG. 1, a processor, one or more other circuits or components configured to send the particular set of bit values based on the determination, or any combination thereof.

Also, in conjunction with the described implementations, an apparatus includes means for receiving, at a receiver of the device, a first set of bit values via a first subset of wires of a set of wires of a communication link during a first transmission period. For example, the means for receiving the first set of bit values can correspond to a link decoder 134, a receiver 144, the device 102, the system 100 of FIG. 1, a processor, one or more other circuits or components configured to receive the first set of bit values via a first subset of wires of a set of wires of a communication link during a first transmission period, or any combination thereof.

The apparatus also includes means for receiving, at the receiver, a second set of bit values via the first subset of wires during a second transmission period. For example, the means for receiving the second set of bit values can correspond to a link decoder 134, a receiver 144, the device 102, the system 100 of FIG. 1, a processor, one or more other circuits or components configured to receive the second set of bit values via the first subset of wires during a second transmission period, or any combination thereof.

The apparatus further includes means for receiving, at the receiver, a third set of bit values via the first subset of wires during a third transmission period. For example, the means for receiving the third set of bit values can correspond to a link decoder 134, a receiver 144, the device 102, the system 100 of FIG. 1, a processor, one or more other circuits or components configured to receive the third set of bit values via the first subset of wires during a third transmission period, or any combination thereof.

The apparatus also includes means for determining, at the receiver, whether a first transition pattern is detected based on a comparison of the first set of bit values and the second set of bit values. For example, the means for determining whether the first transition pattern is detected can correspond to a link decoder 134, a receiver 144, the device 102, the system 100 of FIG. 1, a processor, one or more other circuits or components configured to determine whether the first transition pattern is detected, or any combination thereof.

The apparatus further includes means for determining, at the receiver, whether a second transition pattern is detected based on a comparison of the second set of bit values and the third set of bit values. For example, the means for determining whether the second transition pattern is detected can correspond to a link decoder 134, a receiver 144, the device 102, the system 100 of FIG. 1, a processor, one or more other circuits or components configured to determine whether the second transition pattern is detected, or any combination thereof.

The apparatus also includes means for outputting, based at least in part on determining that each of the first transition pattern and the second transition pattern is detected, the third set of bit values as decoded data. For example, the means for outputting can correspond to a link decoder 134, a receiver 144, the device 102, the system 100 of FIG. 1, a processor, one or more other circuits or components configured to output decoded data, or any combination thereof.

One or more of the components, processes, features, and/or functions illustrated in FIGS. 1-15 may be rearranged and/or combined into a single component, process, feature or function or embodied in several components, processes, or functions. Additional elements, components, processes, and/or functions may also be added without departing from the disclosure. In some implementations, FIGS. 1-15 and its corresponding description may be used to manufacture, create, provide, and/or produce devices and/or integrated devices.

It is noted that the figures in the disclosure may represent actual representations and/or conceptual representations of various parts, components, objects, devices, packages, integrated devices, integrated circuits, and/or transistors. In some instances, the figures may not be to scale. In some instances, for purpose of clarity, not all components and/or parts may be shown. In some instances, the position, the location, the sizes, and/or the shapes of various parts and/or components in the figures may be exemplary. In some implementations, various components and/or parts in the figures may be optional.

Also, it is noted that various disclosures contained herein may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed.

Particular aspects of the disclosure are described below in sets of interrelated Examples:

According to Example 1, a device includes a transmitter configured to: obtain a particular set of bit values to be sent via a set of wires of a communication link; determine, based on a transition pattern associated with the particular set of bit values, whether to send the particular set of bit values during a single transmission period or during multiple transmission periods; and send the particular set of bit values based on the determination.

Example 2 includes the device of Example 1, wherein the transmitter is configured to, based on determining that the transition pattern matches a cross-talk pattern, determine that the particular set of bit values are to be sent during the multiple transmission periods.

Example 3 includes the device of Example 2, wherein the cross-talk pattern includes two adjacent bits transitioning in opposite directions.

Example 4 includes the device of any of Examples 1 to 3, wherein the transmitter is configured to, based on determining that the transition pattern matches an encoding pattern, determine that the particular set of bit values are to be sent during the multiple transmission periods.

Example 5 includes the device of Example 4, wherein the transmitter is configured to: determine that a first set of bit values has been sent via a first subset of wires of the set of wires during a previous first transmission period; determine that a second set of bit values has been sent via the first subset of wires during a previous second transmission period; determine whether a first transition pattern is detected based on a comparison of the first set of bit values and the second set of bit values; determine whether a second transition pattern is detected based on a comparison of the second set of bit values and the set of bit values; and based on determining that each of the first transition pattern and the second transition pattern is detected, determine that the transition pattern matches the encoding pattern.

Example 6 includes the device of any of Examples 1 to 5, wherein the transmitter is configured to, based on determining that the transition pattern matches neither a cross-talk pattern nor an encoding pattern, determine that the particular set of bit values are to be sent during the single transmission period.

Example 7 includes the device of any of Examples 1 to 6, wherein the transmitter is configured to, based on the determination that the particular set of bit values are to be sent during two transmission periods, send alternate bit values of the particular set of bit values via a first subset of wires of the set of wires during each of the two transmission periods.

Example 8 includes the device of any of Examples 1 to 7, wherein a first subset of wires of the set of wires includes even wires and odd wires, wherein the particular set of bit values includes even bit values and odd bit values, and wherein the transmitter is configured to, based on the determination that the particular set of bit values are to be sent during two transmission periods: during a first transmission period, keep the even wires static and send the odd bit values via the odd wires; and during a second transmission period, keep the odd wires static and send the even bit values via the even wires.

Example 9 includes the device of any of Examples 1, 2, 3, 7, or 8, wherein the set of wires includes a flag wire associated with a first subset of wires of the set of wires, wherein the transmitter is configured to send a flag bit value via the flag wire concurrently with sending the particular set of bit values via the first subset of wires, and wherein the flag bit value indicates whether the single transmission period or the multiple transmission periods are being used to send the particular set of bit values.

Example 10 includes the device of any of Examples 1 to 9, wherein each set of the particular set of bit values, a second set of bit values, and a third set of bit values is to be sent via a respective subset of the set of wires, and wherein the transmitter is configured to, based on determining that the particular set of bit values is to be sent during the multiple transmission periods: during a first transmission period, send a first subset of the particular set of bit values via a first subset of wires of the set of wires and send the second set of bit values via a second subset of wires of the set of wires; and during a second transmission period, send a second subset of the particular set of bit values via the first subset of wires and send the third set of bit values via the second subset of wires.

Example 11 includes the device of any of Examples 1 to 10, further comprising a receiver configured to: receive a first set of bit values via a first subset of wires of the set of wires during a first transmission period; receive a second set of bit values via the first subset of wires during a second transmission period; receive a third set of bit values via the first subset of wires during a third transmission period; determine whether a first transition pattern is detected based on a comparison of the first set of bit values and the second set of bit values; determine whether a second transition pattern is detected based on a comparison of the second set of bit values and the third set of bit values; and based at least in part on determining that each of the first transition pattern and the second transition pattern is detected, output the third set of bit values as decoded data.

Example 12 includes the device of any of Examples 1 to 3 or 7 to 11, further comprising a receiver configured to: receive a first set of bit values via a first subset of wires of the set of wires during a first transmission period; receive, during the first transmission period, a first flag bit value via a flag wire associated with the first subset of wires; receive a second set of bit values via the first subset of wires during a second transmission period; receive, during the second transmission period, a second flag bit value via the flag wire; and based at least in part on determining that each of the first flag bit value and the second flag bit value indicates that the multiple transmission periods are being used, output the second set of bit values as decoded data.

According to Example 13, a method includes: obtaining, at a transmitter of a device, a particular set of bit values to be sent via a set of wires of a communication link; determining, based on a transition pattern associated with the particular set of bit values, whether to send the particular set of bit values during a single transmission period or during multiple transmission periods; and sending, via the transmitter, the particular set of bit values based on the determination.

Example 14 includes the method of Example 13, wherein the determination that the particular set of bit values are to be sent during the multiple transmission periods is based on determining that the transition pattern matches a cross-talk pattern.

Example 15 includes the method of Example 14, wherein the cross-talk pattern includes two adjacent bits transitioning in opposite directions.

Example 16 includes the method of any of Examples 13 to 15, wherein the determination that the particular set of bit values are to be sent during the multiple transmission periods is based on determining that the transition pattern matches an encoding pattern.

Example 17 includes the method of Example 16, further comprising: determining, at the transmitter, that a first set of bit values has been sent via a first subset of wires of the set of wires during a previous first transmission period; determining, at the transmitter, that a second set of bit values has been sent via the first subset of wires during a previous second transmission period; determining, at the transmitter, whether a first transition pattern is detected based on a comparison of the first set of bit values and the second set of bit values; and determining, at the transmitter, whether a second transition pattern is detected based on a comparison of the second set of bit values and the particular set of bit values, wherein the transition pattern is determined to match the encoding pattern based on determining that each of the first transition pattern and the second transition pattern is detected.

Example 18 includes the method of any of Examples 13 to 17, wherein the determination that the particular set of bit values are to be sent during the single transmission period is based on determining that the transition pattern matches neither a cross-talk pattern nor an encoding pattern.

Example 19 includes the method of any of Examples 13 to 18, further comprising, based on the determination that the particular set of bit values are to be sent during two transmission periods, sending alternate bit values of the particular set of bit values via a first subset of wires of the set of wires during each of the two transmission periods.

Example 20 includes the method of any of Examples 13 to 19, wherein a first subset of wires of the set of wires includes even wires and odd wires, wherein the particular set of bit values includes even bit values and odd bit values, and the method further comprising, based on the determination that the particular set of bit values are to be sent during two transmission periods: during a first transmission period, keeping the even wires static and sending the odd bit values via the odd wires; and during a second transmission period, keeping the odd wires static and sending the even bit values via the even wires.

Example 21 includes the method of any of Examples 13, 14, 15, 19, or 20, further comprising sending a flag bit value via a flag wire of the set of wires concurrently with sending the particular set of bit values via a first subset of wires of the set of wires, wherein the flag bit value indicates whether the single transmission period or the multiple transmission periods are being used to send the particular set of bit values.

Example 22 includes the method of any of Examples 13 to 21, further comprising, based on determining that each set of the particular set of bit values, a second set of bit values, and a third set of bit values is to be sent via a respective subset of the set of wires and that the particular set of bit values is to be sent during the multiple transmission periods: during a first transmission period, sending a first subset of the particular set of bit values via a first subset of wires of the set of wires and send the second set of bit values via a second subset of wires of the set of wires; and during a second transmission period, sending a second subset of the particular set of bit values via the first subset of wires and send the third set of bit values via the second subset of wires.

Example 23 includes the method of any of Examples 13 to 22, further comprising: receiving, at a receiver of the device, a first set of bit values via a first subset of wires of the set of wires during a first transmission period; receiving, at the receiver, a second set of bit values via the first subset of wires during a second transmission period; receiving, at the receiver, a third set of bit values via the first subset of wires during a third transmission period; determining, at the receiver, whether a first transition pattern is detected based on a comparison of the first set of bit values and the second set of bit values; determining, at the receiver, whether a second transition pattern is detected based on a comparison of the second set of bit values and the third set of bit values; and based at least in part on determining that each of the first transition pattern and the second transition pattern is detected, outputting the third set of bit values as decoded data.

Example 24 includes the method of any of Examples 13 to 15 or 19 to 23, further comprising: receiving, at a receiver, a first set of bit values via a first subset of wires of the set of wires during a first transmission period; receiving, during the first transmission period at the receiver, a first flag bit value via a flag wire associated with the first subset of wires; receiving, at the receiver, a second set of bit values via the first subset of wires during a second transmission period; receiving, during the second transmission period at the receiver, a second flag bit value via the flag wire; and based at least in part on determining that each of the first flag bit value and the second flag bit value indicates that the multiple transmission periods are being used, outputting the second set of bit values as decoded data.

According to Example 25, a non-transitory computer-readable medium stores instructions that, when executed by at least one processor, cause the at least one processor to: obtain, at a transmitter of a device, a particular set of bit values to be sent via a set of wires of a communication link; determine, based on a transition pattern associated with the particular set of bit values, whether to send the particular set of bit values during a single transmission period or during multiple transmission periods; and send, via the transmitter, the particular set of bit values based on the determination.

Example 26 includes the non-transitory computer-readable medium of Example 25, wherein the determination that the particular set of bit values are to be sent during the multiple transmission periods is based on determining that the transition pattern matches a cross-talk pattern.

Example 27 includes the non-transitory computer-readable medium of Example 26, wherein the cross-talk pattern includes two adjacent bits transitioning in opposite directions.

Example 28 includes the non-transitory computer-readable medium of any of Examples 25 to 27, wherein the determination that the particular set of bit values are to be sent during the multiple transmission periods is based on determining that the transition pattern matches an encoding pattern.

According to Example 29, an apparatus includes: means for obtaining, at a transmitter of a device, a particular set of bit values to be sent via a set of wires of a communication link; means for determining, based on a transition pattern associated with the particular set of bit values, whether to send the particular set of bit values during a single transmission period or during multiple transmission periods; and means for sending, via the transmitter, the particular set of bit values based on the determination.

Example 30 includes the apparatus of Example 29, wherein the means for obtaining, the means for determining, and the means for sending are integrated into at least one of a communication device, a computer, a display device, a gaming console, a music player, a camera, a navigation device, a vehicle, a headset, a home automation system, a voice-activated device, an internet-of-things (IoT) device, an extended reality (XR) device, a base station, or a mobile device.

According to Example 31, a device includes a receiver configured to: receive a first set of bit values via a first subset of wires of a set of wires of a communication link during a first transmission period; receive a second set of bit values via the first subset of wires during a second transmission period; receive a third set of bit values via the first subset of wires during a third transmission period; determine whether a first transition pattern is detected based on a comparison of the first set of bit values and the second set of bit values; determine whether a second transition pattern is detected based on a comparison of the second set of bit values and the third set of bit values; and based at least in part on determining that each of the first transition pattern and the second transition pattern is detected, output the third set of bit values as decoded data.

According to Example 32, a method includes: receiving, at a receiver of a device, a first set of bit values via a first subset of wires of a set of wires of a communication link during a first transmission period; receiving, at the receiver, a second set of bit values via the first subset of wires during a second transmission period; receiving, at the receiver, a third set of bit values via the first subset of wires during a third transmission period; determining, at the receiver, whether a first transition pattern is detected based on a comparison of the first set of bit values and the second set of bit values; determining, at the receiver, whether a second transition pattern is detected based on a comparison of the second set of bit values and the third set of bit values; and based at least in part on determining that each of the first transition pattern and the second transition pattern is detected, outputting the third set of bit values as decoded data.

According to Example 33, a non-transitory computer readable storage medium stores instructions that, when executed by at least one processor, cause the at least one processor to: receive, at a receiver, a first set of bit values via a first subset of wires of a set of wires of a communication link during a first transmission period; receive, at the receiver, a second set of bit values via the first subset of wires during a second transmission period; receive, at the receiver, a third set of bit values via the first subset of wires during a third transmission period; determine, at the receiver, whether a first transition pattern is detected based on a comparison of the first set of bit values and the second set of bit values; determine, at the receiver, whether a second transition pattern is detected based on a comparison of the second set of bit values and the third set of bit values; and based at least in part on determining that each of the first transition pattern and the second transition pattern is detected, output the third set of bit values as decoded data.

According to Example 34, an apparatus includes: means for receiving, at a receiver of a device, a first set of bit values via a first subset of wires of a set of wires of a communication link during a first transmission period; means for receiving, at the receiver, a second set of bit values via the first subset of wires during a second transmission period; means for receiving, at the receiver, a third set of bit values via the first subset of wires during a third transmission period; means for determining, at the receiver, whether a first transition pattern is detected based on a comparison of the first set of bit values and the second set of bit values; means for determining, at the receiver, whether a second transition pattern is detected based on a comparison of the second set of bit values and the third set of bit values; and means for outputting the third set of bit values as decoded data based at least in part on determining that each of the first transition pattern and the second transition pattern is detected.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a transmitter configured to:
obtain a particular set of bit values to be sent via a set of wires of a communication link;
determine, based on a transition pattern associated with the particular set of bit values, whether to send the particular set of bit values during a single transmission period or during multiple transmission periods; and
send the particular set of bit values based on the determination.

2. The device of claim 1, wherein the transmitter is configured to, based on determining that the transition pattern matches a cross-talk pattern, determine that the particular set of bit values are to be sent during the multiple transmission periods.

3. The device of claim 2, wherein the cross-talk pattern includes two adjacent bits transitioning in opposite directions.

4. The device of claim 1, wherein the transmitter is configured to, based on determining that the transition pattern matches an encoding pattern, determine that the particular set of bit values are to be sent during the multiple transmission periods.

5. The device of claim 4, wherein the transmitter is configured to:
determine that a first set of bit values has been sent via a first subset of wires of the set of wires during a previous first transmission period;
determine that a second set of bit values has been sent via the first subset of wires during a previous second transmission period;
determine whether a first transition pattern is detected based on a comparison of the first set of bit values and the second set of bit values;
determine whether a second transition pattern is detected based on a comparison of the second set of bit values and the set of bit values; and
based on determining that each of the first transition pattern and the second transition pattern is detected, determine that the transition pattern matches the encoding pattern.

6. The device of claim 1, wherein the transmitter is configured to, based on determining that the transition pattern matches neither a cross-talk pattern nor an encoding pattern, determine that the particular set of bit values are to be sent during the single transmission period.

7. The device of claim 1, wherein the transmitter is configured to, based on the determination that the particular set of bit values are to be sent during two transmission periods, send alternate bit values of the particular set of bit values via a first subset of wires of the set of wires during each of the two transmission periods.

8. The device of claim 1, wherein a first subset of wires of the set of wires includes even wires and odd wires, wherein the particular set of bit values includes even bit values and odd bit values, and wherein the transmitter is configured to, based on the determination that the particular set of bit values are to be sent during two transmission periods:
during a first transmission period, keep the even wires static and send the odd bit values via the odd wires; and
during a second transmission period, keep the odd wires static and send the even bit values via the even wires.

9. The device of claim 1, wherein the set of wires includes a flag wire associated with a first subset of wires of the set of wires, wherein the transmitter is configured to send a flag bit value via the flag wire concurrently with sending the particular set of bit values via the first subset of wires, and wherein the flag bit value indicates whether the single transmission period or the multiple transmission periods are being used to send the particular set of bit values.

10. The device of claim 1, wherein each set of the particular set of bit values, a second set of bit values, and a third set of bit values is to be sent via a respective subset of the set of wires, and wherein the transmitter is configured to, based on determining that the particular set of bit values is to be sent during the multiple transmission periods:
during a first transmission period, send a first subset of the particular set of bit values via a first subset of wires of the set of wires and send the second set of bit values via a second subset of wires of the set of wires; and
during a second transmission period, send a second subset of the particular set of bit values via the first subset of wires and send the third set of bit values via the second subset of wires.

11. The device of claim 1, further comprising a receiver configured to:
receive a first set of bit values via a first subset of wires of the set of wires during a first transmission period;
receive a second set of bit values via the first subset of wires during a second transmission period;
receive a third set of bit values via the first subset of wires during a third transmission period;
determine whether a first transition pattern is detected based on a comparison of the first set of bit values and the second set of bit values;
determine whether a second transition pattern is detected based on a comparison of the second set of bit values and the third set of bit values; and
based at least in part on determining that each of the first transition pattern and the second transition pattern is detected, output the third set of bit values as decoded data.

12. The device of claim 1, further comprising a receiver configured to:
receive a first set of bit values via a first subset of wires of the set of wires during a first transmission period;
receive, during the first transmission period, a first flag bit value via a flag wire associated with the first subset of wires;
receive a second set of bit values via the first subset of wires during a second transmission period;
receive, during the second transmission period, a second flag bit value via the flag wire; and
based at least in part on determining that each of the first flag bit value and the second flag bit value indicates that the multiple transmission periods are being used, output the second set of bit values as decoded data.

13. A method comprising:
obtaining, at a transmitter of a device, a particular set of bit values to be sent via a set of wires of a communication link;
determining, based on a transition pattern associated with the particular set of bit values, whether to send the particular set of bit values during a single transmission period or during multiple transmission periods; and
sending, via the transmitter, the particular set of bit values based on the determination.

14. The method of claim 13, wherein the determination that the particular set of bit values are to be sent during the multiple transmission periods is based on determining that the transition pattern matches a cross-talk pattern.

15. The method of claim 14, wherein the cross-talk pattern includes two adjacent bits transitioning in opposite directions.

16. The method of claim 13, wherein the determination that the particular set of bit values are to be sent during the multiple transmission periods is based on determining that the transition pattern matches an encoding pattern.

17. The method of claim 16, further comprising:
determining, at the transmitter, that a first set of bit values has been sent via a first subset of wires of the set of wires during a previous first transmission period;
determining, at the transmitter, that a second set of bit values has been sent via the first subset of wires during a previous second transmission period;
determining, at the transmitter, whether a first transition pattern is detected based on a comparison of the first set of bit values and the second set of bit values; and
determining, at the transmitter, whether a second transition pattern is detected based on a comparison of the second set of bit values and the particular set of bit values,
wherein the transition pattern is determined to match the encoding pattern based on determining that each of the first transition pattern and the second transition pattern is detected.

18. The method of claim 13, wherein the determination that the particular set of bit values are to be sent during the single transmission period is based on determining that the transition pattern matches neither a cross-talk pattern nor an encoding pattern.

19. The method of claim 13, further comprising, based on the determination that the particular set of bit values are to be sent during two transmission periods, sending alternate bit values of the particular set of bit values via a first subset of wires of the set of wires during each of the two transmission periods.

20. The method of claim 13, wherein a first subset of wires of the set of wires includes even wires and odd wires, wherein the particular set of bit values includes even bit values and odd bit values, and the method further comprising, based on the determination that the particular set of bit values are to be sent during two transmission periods:
during a first transmission period, keeping the even wires static and sending the odd bit values via the odd wires; and
during a second transmission period, keeping the odd wires static and sending the even bit values via the even wires.

21. The method of claim 13, further comprising sending a flag bit value via a flag wire of the set of wires concurrently with sending the particular set of bit values via a first subset of wires of the set of wires, wherein the flag bit value indicates whether the single transmission period or the multiple transmission periods are being used to send the particular set of bit values.

22. The method of claim 13, further comprising, based on determining that each set of the particular set of bit values, a second set of bit values, and a third set of bit values is to be sent via a respective subset of the set of wires and that the particular set of bit values is to be sent during the multiple transmission periods:
during a first transmission period, sending a first subset of the particular set of bit values via a first subset of wires of the set of wires and send the second set of bit values via a second subset of wires of the set of wires; and
during a second transmission period, sending a second subset of the particular set of bit values via the first subset of wires and send the third set of bit values via the second subset of wires.

23. The method of claim 13, further comprising:
receiving, at a receiver of the device, a first set of bit values via a first subset of wires of the set of wires during a first transmission period;
receiving, at the receiver, a second set of bit values via the first subset of wires during a second transmission period;
receiving, at the receiver, a third set of bit values via the first subset of wires during a third transmission period;
determining, at the receiver, whether a first transition pattern is detected based on a comparison of the first set of bit values and the second set of bit values;
determining, at the receiver, whether a second transition pattern is detected based on a comparison of the second set of bit values and the third set of bit values; and
based at least in part on determining that each of the first transition pattern and the second transition pattern is detected, outputting the third set of bit values as decoded data.

24. The method of claim 13, further comprising:
receiving, at a receiver, a first set of bit values via a first subset of wires of the set of wires during a first transmission period;
receiving, during the first transmission period at the receiver, a first flag bit value via a flag wire associated with the first subset of wires;
receiving, at the receiver, a second set of bit values via the first subset of wires during a second transmission period;
receiving, during the second transmission period at the receiver, a second flag bit value via the flag wire; and
based at least in part on determining that each of the first flag bit value and the second flag bit value indicates that the multiple transmission periods are being used, outputting the second set of bit values as decoded data.

25. A non-transitory computer-readable medium storing instructions that, when executed by at least one processor, cause the at least one processor to:
obtain, at a transmitter of a device, a particular set of bit values to be sent via a set of wires of a communication link;
determine, based on a transition pattern associated with the particular set of bit values, whether to send the particular set of bit values during a single transmission period or during multiple transmission periods; and
send, via the transmitter, the particular set of bit values based on the determination.

26. The non-transitory computer-readable medium of claim 25, wherein the determination that the particular set of bit values are to be sent during the multiple transmission periods is based on determining that the transition pattern matches a cross-talk pattern.

27. The non-transitory computer-readable medium of claim 26, wherein the cross-talk pattern includes two adjacent bits transitioning in opposite directions.

28. The non-transitory computer-readable medium of claim 25, wherein the determination that the particular set of bit values are to be sent during the multiple transmission periods is based on determining that the transition pattern matches an encoding pattern.

29. An apparatus comprising:
means for obtaining, at a transmitter of a device, a particular set of bit values to be sent via a set of wires of a communication link;
means for determining, based on a transition pattern associated with the particular set of bit values, whether to send the particular set of bit values during a single transmission period or during multiple transmission periods; and
means for sending, via the transmitter, the particular set of bit values based on the determination.

30. The apparatus of claim 29, wherein the means for obtaining, the means for determining, and the means for sending are integrated into at least one of a communication device, a computer, a display device, a gaming console, a music player, a camera, a navigation device, a vehicle, a headset, a home automation system, a voice-activated device, an internet-of-things (IoT) device, an extended reality (XR) device, a base station, or a mobile device.
